(19) United States
(12) Patent Application Publication
(10) Pub. No.: US 2017/0227941 A1
(43) Pub. Date: Aug. 10, 2017

(54) CONTROL APPARATUS AND DEVICE CONTROL SYSTEM

(71) Applicants: Kiriko CHOSOKABE, Tokyo (JP); Yuji OHUE, Kanagawa (JP); Kazunari TONAMI, Kanagawa (JP); Akira MURAKATA, Tokyo (JP); Akiyoshi NAKAI, Kanagawa (JP); Hideaki IIJIMA, Kanagawa (JP); Yushi MIYATA, Tokyo (JP)

(72) Inventors: Kiriko CHOSOKABE, Tokyo (JP); Yuji OHUE, Kanagawa (JP); Kazunari TONAMI, Kanagawa (JP); Akira MURAKATA, Tokyo (JP); Akiyoshi NAKAI, Kanagawa (JP); Hideaki IIJIMA, Kanagawa (JP); Yushi MIYATA, Tokyo (JP)

(73) Assignee: Ricoh Company, Ltd., Tokyo (JP)

(21) Appl. No.: 15/418,947

(22) Filed: Jan. 30, 2017

(30) Foreign Application Priority Data
Feb. 10, 2016 (JP) 2016-024167

(51) Int. Cl. G05B 19/048; H05B 33/08; F24F 11/00; H05B 37/02

(52) U.S. Cl. CPC G05B 19/048; H05B 37/0272; H05B 33/0842; H05B 37/0227; F24F 11/0012; G05B 2219/2642; G05B 2219/2614

(57) ABSTRACT

A control apparatus is provided that controls a lighting apparatus and an air conditioning apparatus installed in a predetermined space by communicating with an environmental information acquiring apparatus that acquires environmental information relating to an environmental condition of the predetermined space. The control apparatus includes a processor that executes a program stored in a memory to implement processes of acquiring the environmental information from the environmental information acquiring apparatus, and generating control data for the lighting apparatus and the air conditioning apparatus based on the acquired environmental information and control guideline information that is set up in advance in association with the acquired environmental information.

### CROSS-REFERENCE TO RELATED APPLICATIONS

The present application claims priority under 35 U.S.C. §119 to Japanese Patent Application No. 2016-024167 filed on Feb. 10, 2016, the entire contents of which are incorporated herein by reference.

### BACKGROUND OF THE INVENTION

1. Field of the Invention

The present disclosure relates to a control apparatus and a device control system.

2. Description of the Related Art

Systems that automatically control air conditioning of a room where people work or take breaks are known. In such systems, for example, air conditioning may be automatically started when the presence of a person is detected by a human sensor, such as an infrared sensor, and air conditioning may be automatically stopped when the sensor detects that everyone has left the room. In this way, comfort may be improved without requiring a person to operate an air conditioner and power consumption may be reduced.

However, a system using a human sensor such as an infrared sensor may not necessarily be suitable for a work space such as an office where a large number of people move around and a large number of obstacles are present. This is because a temperature distribution tends to be created in a work space such as an office that is relatively large. As a result, some people may feel hot while others may feel cold and comfort may be degraded.

In response to such inconvenience, techniques are being developed for appropriately controlling air conditioning to control the temperature around users. For example, Japanese Unexamined Patent Publication No. 2015-132443 describes a device control system that controls air conditioning by determining whether a user has stopped moving based on data relating to the user's amount of activity over the past predetermined period of time, and upon determining that the user has stopped moving, changing temperature setting information for an area including the position where the user has stopped.

### SUMMARY OF THE INVENTION

According to one embodiment of the present invention, a control apparatus is provided that controls a lighting apparatus and an air conditioning apparatus installed in a predetermined space by communicating with an environmental information acquiring apparatus that acquires environmental information relating to an environmental condition of the predetermined space. The control apparatus includes a processor that executes a program stored in a memory to implement processes of acquiring the environmental information from the environmental information acquiring apparatus, and generating control data for the lighting apparatus and the air conditioning apparatus based on the acquired environmental information and control guideline information that is set up in advance in association with the acquired environmental information.

### BRIEF DESCRIPTION OF THE DRAWINGS

FIG. 1 is a diagram illustrating an example schematic configuration of a device control system according to an embodiment of the present invention;

FIG. 2 is a an example external perspective view of an LED lighting apparatus as an example of a first control target apparatus;

FIGS. 3A and 3B are block diagrams illustrating example hardware configurations of a detection apparatus and a first/second control target apparatus;

FIG. 4 is a block diagram illustrating an example hardware configuration of a management system;

FIG. 5 is a diagram illustrating an example functional configuration of the device control system;

FIGS. 6A and 6B are diagrams describing information stored in a layout management database;

FIGS. 7A and 7B are diagrams describing information stored in a control guideline management database;

FIG. 8 is a diagram describing information stored in a control area management database;

FIGS. 9A and 9B are diagrams describing the concept of a population density;

FIG. 10 is a sequence chart illustrating an example process implemented by the management system;

FIGS. 11A and 11B are example conceptual diagrams of temperature distribution data and heat source data;

FIG. 12 is a diagram illustrating an example of heat source data obtained by synthesizing heat source data transmitted from a plurality of first control target apparatuses having detection apparatuses;

FIG. 13 is a flowchart illustrating an example method of generating heat source data according to a first pattern;

FIGS. 14A and 14B are example conceptual diagrams of temperature distribution data and heat source data for describing the first pattern;

FIG. 15 is a flowchart illustrating an example method of generating heat source data according to a second pattern;

FIGS. 16A and 16B are example conceptual diagrams of temperature distribution data and heat source data for describing the second pattern;

FIGS. 17A and 17B are graphs indicating example temperature changes in a certain area;

FIG. 18 is a flowchart illustrating a method of generating heat source data according to a third pattern;

FIGS. 19A and 19B are example conceptual diagrams of temperature distribution data and heat source data for describing the third pattern;

FIGS. 20A-20C are diagrams describing the relationship between the number of temperature distribution sensors and their corresponding detection ranges;

FIGS. 21A-21C are diagrams illustrating detection ranges of temperature distribution sensors and corresponding areas of a predetermined space;

FIG. 22 is a flowchart illustrating a process implemented by a cell conversion process unit of the management system for associating a detection cell of a detection range with a corresponding area;

FIG. 23 is a diagram illustrating center coordinates of a detection cell to be detected by a thermopile sensor;

FIG. 24 is a flowchart illustrating an example process implemented by a generation unit for generating control data for the first control target apparatus relating to the amount of light to be output by the first control target apparatus; and

FIG. 25 is a flowchart illustrating an example process implemented by the generation unit for generating air conditioning control data for the second control target apparatus.

### DESCRIPTION OF THE EMBODIMENTS

Comfort for occupants of a space such as an office is influenced not only by temperature and humidity but also illuminance. Thus, detecting the presence of occupants and appropriately controlling lighting based on the detection result may be desired. For example, comfort and energy conservation may be improved by turning on the lights of an area where a person is present and turning off the lights of an area where no person is present. However, oftentimes, lights are uniformly turned on/off for the entire room or zone, and it has been difficult to individually control the lights of a space such as an office.

An aspect of the present invention is directed to providing a control apparatus that is capable of controlling both air conditioning and lighting of a space in consideration of comfort for occupants and energy conservation.

In the following, embodiments of the present invention are described with reference to the accompanying drawings.

<Device Control System>

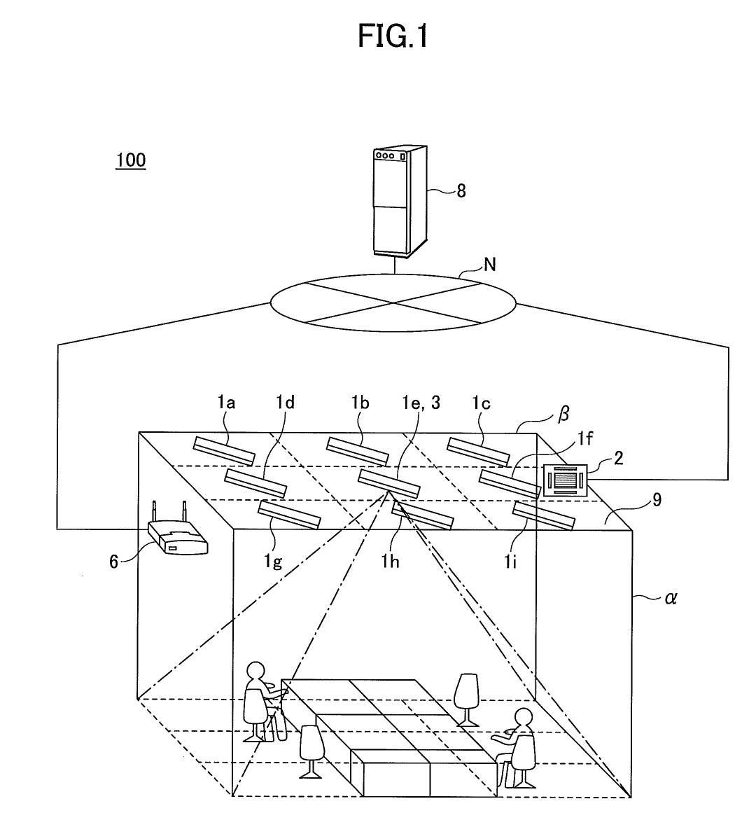

FIG. 1 is a diagram illustrating an example schematic configuration of a device control system 100 according to an embodiment of the present embodiment. The device control system 100 includes a plurality of first control target apparatuses 1a, 1b, 1c, 1d, 1e, 1f, 1g, 1h, and 1i installed on a ceiling β of a room α corresponding to an example of a predetermined space, a second control target apparatus 2, a wireless router 6, and a management system 8 that are capable of communicating with each other via a communication network N. Note that in the following descriptions, an arbitrary first control target apparatus among the plurality of first control target apparatuses 1a, 1b, 1c, 1d, 1e, 1f, 1g, 1h, and 1i may generically be referred to as “first control target apparatus 1”.

In FIG. 1, the ceiling β is divided into nine areas 9, and the first control target apparatus 1 is installed in each of the areas 9. A detection apparatus 3 is provided in the first control target apparatus 1e arranged at the center of the ceiling β. The size of each area 9 may be 50 square centimeters (cm²) to several square meters (m²), for example. However, the size of the area 9 is not particularly limited and may be suitably set up according to the size and performance of the first control target apparatus 1, for example. Also, the areas 9 into which the ceiling β are divided do not necessarily have to be the same size and the areas 9 do not necessarily have to be squares. For example, the areas 9 may be arranged into other polygons such as hexagons in which case the distances between the first control target apparatuses 1 may be equal as in the case of arranging the areas 9 into squares.

The second control target apparatus 2 is installed at suitable intervals on the ceiling β. Note the although only one second control target apparatus 2 is illustrated in FIG. 1, a plurality of second control target apparatuses 2 may be installed in one room α as described below. Also, note that although the second control target apparatuses 2 are preferably installed at equal intervals, they do not necessarily have to be installed at equal intervals. The number of first control target apparatuses 1 and the number of second control target apparatuses 2 that are installed in the room α may vary owing to the different ranges that can be covered by the first control target apparatus 1 and the second control target apparatus 2, the difference in size of the first control target apparatus 1 and the second control target apparatus 2, and the difference in cost of the first control target apparatus 1 and the second control target apparatus 2, for example. The number of first control target apparatuses 1 and the number of second control target apparatuses 2 may be arbitrarily determined. Note that in the case where a plurality of second control target apparatuses 2 are provided, the second control target apparatuses 2 may be individually referred to as second control target apparatus 2a, 2b and 2c, for example, and generically referred to as “second control target apparatus 2”.

In the present embodiment, the first control target apparatus 1 is an LED (Light Emitting Diode) lighting apparatus. The detection apparatus 3 included in the first control target apparatus 1e detects a temperature distribution within the room α that is divided into a plurality of areas 9 (e.g., nine areas 9 in FIG. 1) using a thermopile sensor, for example, and transmits heat source data indicating the presence or absence of a heat source to the management system 8. Note that a wireless LAN may be used to transmit the heat source data, for example. However, the heat source data may also be transmitted by wire, for example. The floor of the room α is where a person as an example of a heat source corresponding to a detection target may be present.

The second control target apparatus 2 according to the present embodiment is an air conditioning apparatus (an indoor unit of the second control target apparatus 2 is illustrated in FIG. 1). The outdoor unit of the second control target apparatus 2 may be installed in a predetermined location, which may be individually provided for each second control target apparatus 2 or commonly provided for a plurality of second control target apparatuses 2. In FIG. 1, the second control target apparatus 2 and the management system 8 are connected by wire, but in other embodiments, the second control target apparatus 2 and the management system 8 may communicate wirelessly, for example.

The wireless router 6 receives the heat source data transmitted from the detection apparatus 3 and transmits the heat source data to the management system 8 via the communication network N. The communication network N may be configured by a LAN (Local Area Network) and may also include the Internet in some embodiments, for example.

As described below, the management system 8 has functions of an information processing apparatus and may be referred to as a server. Based on the heat source data transmitted from the wireless router 6, the management system 8 generates control data for controlling the first control target apparatus 1 and the second control target apparatus 2, and transmits the generated control data to the first control target apparatus 1 and the second control target apparatus 2. The first control target apparatus 1 performs LED lighting control based on the control data. The second control object apparatus 2 controls the temperature, humidity, wind power, and wind direction, for example, based on the control data. In this way, the management system 8 can control both lighting and air conditioning to thereby provide a space that is comfortable for occupants in the room while achieving energy conservation.

As can be appreciated from the above description, the first control target apparatus 1e having the detection apparatus 3 installed therein not only detects the temperature distribution within the room α but also performs LED lighting control of a lighting apparatus installed therein. That is, the first control target apparatus 1e includes the detection apparatus 3 but also includes the same functions and features of the other first control target apparatuses 1.

Also, in some embodiments, the detection apparatus 3 may be installed inside or near the second control target apparatus 2. Further, the detection apparatus 3 may be installed separately from the first control target apparatus 1 or the second control target apparatus 2. However, by integrating the detection apparatus 3 with the first control target apparatus 1e, the detection apparatus 3 may be easily installed/removed, and a space for installing the detection apparatus 3 may not be necessary.

<Terminology>

A room may refer to a space to be occupied by a person. Also, a room may be a space to be occupied by a plurality of persons. Specific examples of a room include an office, a factory, a seminar venue, an exhibition space, an indoor stadium, and the like. Also, the home of an individual may be an example of a room as well.

Environmental information refers to information relating to an environmental condition of a room. Also, environmental information may include information relating to a desired environmental condition for enabling a person to comfortably engage in activities. Alternatively, environmental information may include information relating to an environmental condition to be desirably achieved through control such that a person can comfortably engage in activities. Specific examples of environmental information include detection data (heat source data, temperature, humidity, illuminance, etc.) to be described below. However, environmental information is not limited the examples described above.

<First Control Target Apparatus>

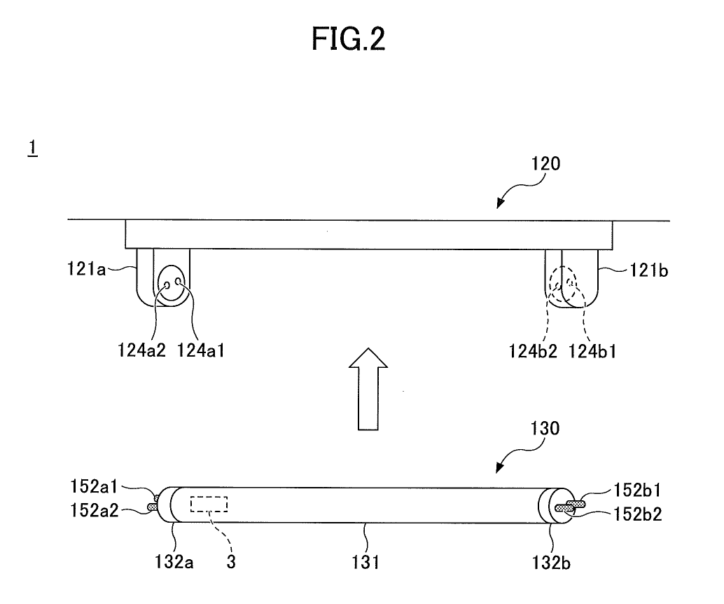

In the following, the first control target apparatus 1 is described with reference to FIG. 2. FIG. 2 is an example external perspective view of an LED lighting apparatus as an example of the first control target apparatus.

In FIG. 2, the first control target apparatus 1 as an LED lighting apparatus includes a main unit 120 and a straight tube-type LED lamp 130 to be attached to the main unit 120. The main unit 120 may be installed around the center of a corresponding area 9 of the ceiling β of the room α, for example. A socket 121a and a socket 121b are respectively provided at the end portions of the main unit 120. The socket 121a includes power supply terminals 124a1 and 124a2 for supplying power to the LED lamp 130.

The socket 121b also includes power supply terminals 124b1 and 124b2 for supplying power to the LED lamp 130. In this way the main unit 120 can supply power from a power source to the LED lamp 130.

The LED lamp 130 includes a translucent cover 131 and bases 132a and 132b respectively provided at the end portions of the translucent cover 131. Note that the first control target apparatus 1e may have the detection apparatus 3 arranged adjacent to the translucent cover 131 or inside the translucent cover 131, for example. The translucent cover 131 may be made of a resin material such as acrylic resin, for example, and is arranged to cover an internal light source.

Further, the base 132a includes terminal pins 152a1 and 152a2 that are respectively connected to the power supply terminals 124a1 and 124a2 of the socket 121a. The base 132b includes terminal pins 152b1 and 152b2 that are respectively connected to the power supply terminals 124b1 and 124b2 of the socket 121b. By attaching the LED lamp 130 to the main unit 120, electric power may be supplied to the LED lamp 130 from the respective terminal pins 152a1, 152a2, 152b1, and 152b2 via the respective power supply terminals 124a1, 124a2, 124b1, and 124b2 of the main unit 120, for example. As a result, the LED lamp 130 may irradiate light to the exterior through the translucent cover 131. Also, the detection apparatus 3 may be run by the electric power supplied from the main unit 120.

<Hardware Configuration of Detection Apparatus, First Control Target Apparatus, and Second Control Target Apparatus>

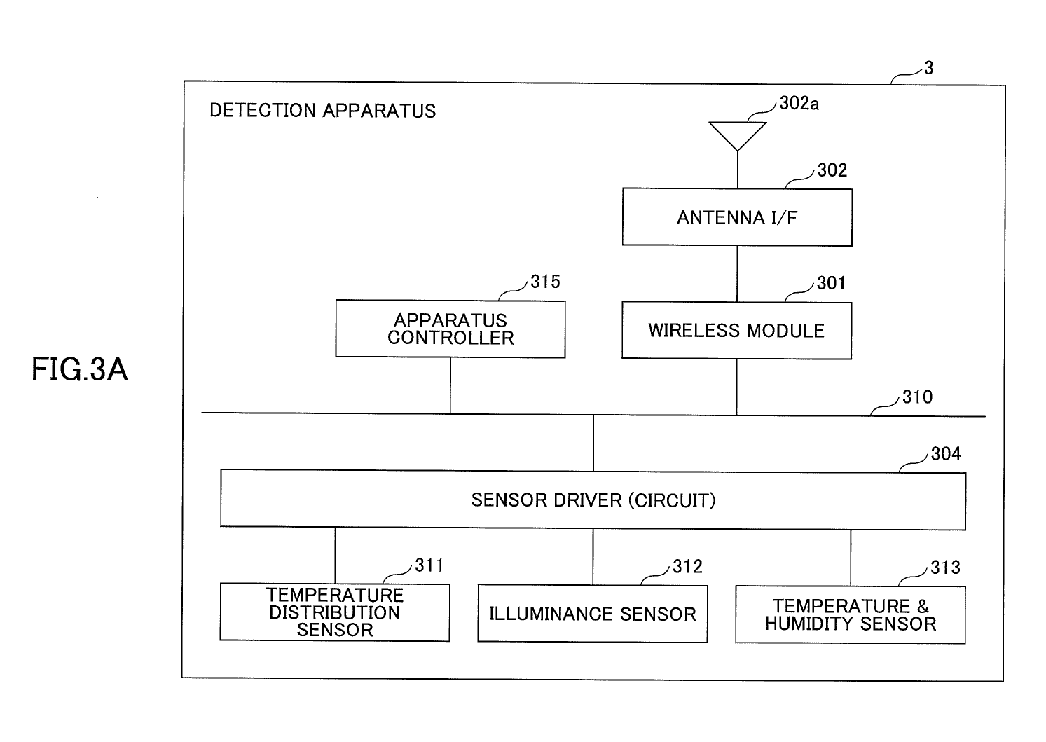

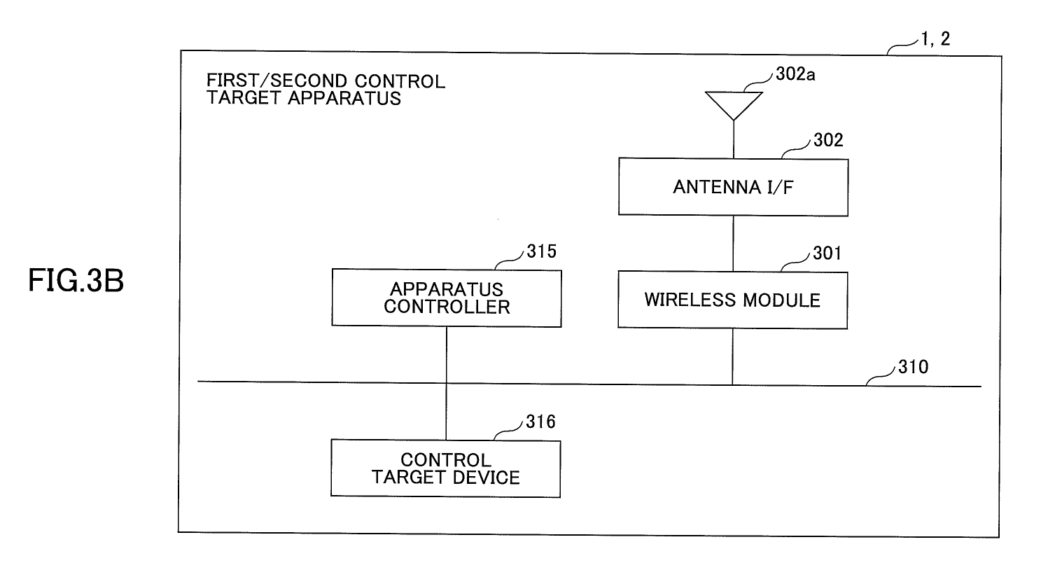

In the following, the hardware configuration of the detection apparatus 3 will be described with reference to FIG. 3A. FIG. 3A is a block diagram illustrating an example hardware configuration of the detection apparatus 3. The detection apparatus 3 includes a wireless module 301, an antenna I/F (interface) 302, an antenna 302a, a sensor driver 304, a temperature distribution sensor 311, an illuminance sensor 312, a temperature and humidity sensor 313, an apparatus controller 315, and a bus line 310, such as an address bus and/or a data bus, for electrically connecting the above hardware elements.

The wireless module 301 establishes wireless communication with an external device via the antenna I/F 302 and the antenna 302a. The wireless module 301 may be configured to establish communication based on a communication system, such as Bluetooth (registered trademark), WiFi, or ZigBee, for example. Note that in some embodiments, wired communication using an Ethernet (registered trademark) cable or PLC (Power Line Communications) may be used instead of wireless communication, for example. The wireless module 301 operates under control of a communication control program executed by the apparatus controller 315.

The temperature distribution sensor 311 is a thermal detection element that detects the temperature distribution within the room α by detecting infrared rays. By using such a thermal detection element, the surface temperature of a person or an object can be detected, and in this way, the temperature of an area where a person is present may be detected. The thermal detection element includes an absorption layer that absorbs and converts light into heat and is configured to output a temperature change of the absorption layer as an electric signal. Specific examples of thermal detection elements include thermopiles, bolometers, pyroelectric elements, diodes with voltage-current characteristics that change, and the like. In the present embodiment, it is assumed that the temperature distribution sensor 311 detects the temperature distribution using a thermopile. The temperature distribution sensor 311 includes a plurality of thermopile sensors and is configured to detect the temperature of each detection cell as described below.

The illuminance sensor 312 is a sensor that detects the illuminance of the room α. The temperature and humidity sensor 313 is a sensor that detects the temperature and humidity around the detection apparatus 3 within the room α. Note that in the present embodiment, the temperature detected by the temperature and humidity sensor 313 may not necessarily be used.

The sensor driver 304 is an interface for the temperature distribution sensor 311, the illuminance sensor 312, and the temperature and humidity sensor 313. The sensor driver 304 converts commands for driving the temperature distribution sensor 311, the illuminance sensor 312, and the temperature and humidity sensor 313 that are transmitted from the apparatus controller 315 into commands compatible with the respective sensors, and transmits the converted commands to the respective sensors. Also, the sensor driver 304 converts signals output by the above sensors into signals in a format compatible with the apparatus controller 315, and transmits the converted signals to the apparatus controller 315.

The apparatus controller 315 is a controller for controlling the entire detection apparatus 3. The apparatus controller 315 may be an information processing apparatus, such as a microcomputer, including a CPU, a ROM, and a RAM for executing a program, for example. Alternatively, the apparatus controller 315 may be configured by hardware such as an IC (integrated chip). For example, the apparatus controller 315 may control the timings at which the temperature distribution sensor 311, the illuminance sensor 312, and the temperature and humidity sensor 313 detect the temperature distribution, the illuminance, and the temperature and humidity, for example, and process data output by these sensors. For example, the apparatus controller 315 may generate heat source data indicating the presence or absence of a heat source based on temperature distribution data output by the temperature distribution sensor 311. The apparatus controller 315 may then transmit detection data including the generated heat source data to the management system 8.

FIG. 3B illustrates an example hardware configuration of the first control target apparatus 1 or the second control target apparatus 2 according to the present embodiment. In FIG. 3B, the first control target apparatus 1 or the second control target apparatus 2 includes the wireless module 301, the antenna I/F 302, the antenna 302a, the apparatus controller 315, the bus line 310, and a control target device 316. The apparatus controller 315 of the first control target apparatus 1 controls LED lighting based on control data transmitted from the management system 8, for example. The apparatus controller 315 of the second control target apparatus 2 controls air conditioning based on control data transmitted from the management system 8, for example.

Note that the antenna I/F 302 and the wireless module 301 of the first control target apparatus 1 or the second control target apparatus 2 may be substantially identical to those of the detection apparatus 3 as described above with reference to FIG. 3A. The first control target apparatus 1 or the second control target apparatus 2 includes the control target device 316. The control target device 316 of the first control target apparatus 1 may include the LED lamp 130 and/or a control circuit of the LED lamp 130, for example. The control target device 316 of the second control target apparatus 2 may include a heat pump, a compressor, and/or a control circuit of an air conditioner, for example.

Note that in the first control target apparatus 1e including the detection apparatus 3, the apparatus controller 315, the antenna I/F 302, and the wireless module 301 may be commonly used to implement functions relating to the detection apparatus 3 and functions relating to lighting control of the first control target apparatus 1e, for example. In this way, the number of components of the detection apparatus 3 may be reduced, for example.

<Hardware Configuration of Management System 8>

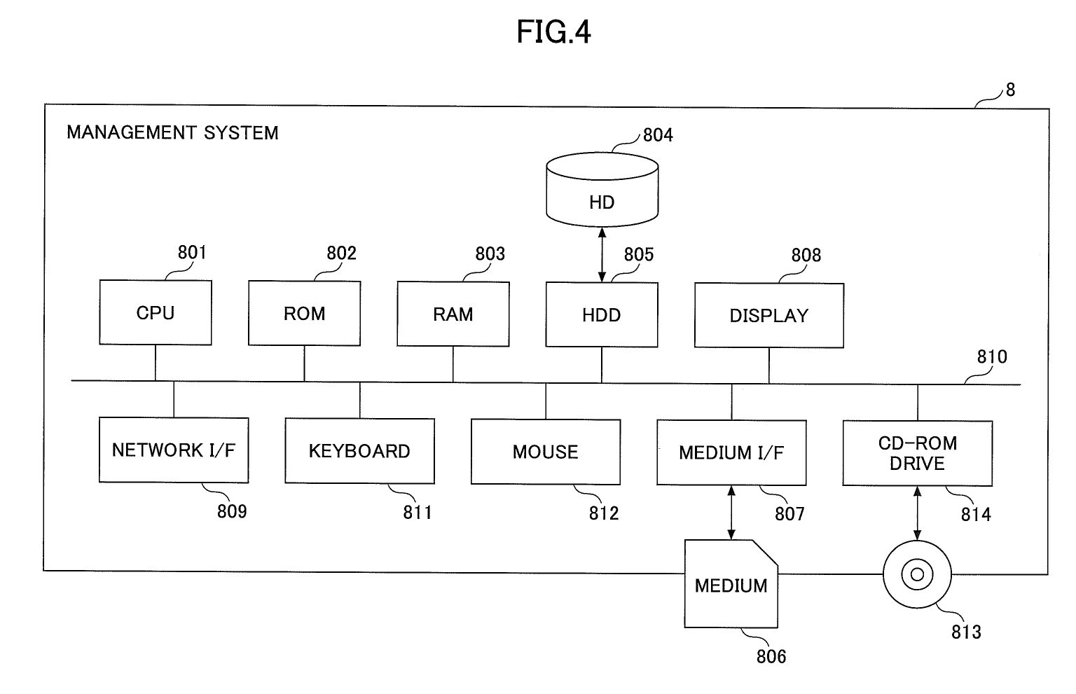

In the following, the hardware configuration of the management system 8 is described. FIG. 4 illustrates an example hardware configuration of the management system 8.

The management system 8 may be implemented by an information processing apparatus, for example.

The management system 8 includes a CPU 801 that controls the overall operations of the management system 8, a ROM 802 that stores programs used for driving the CPU 801 such as an IPL (Initial Program Loader), and a RAM 803 that is used as a work area of the CPU 801. The management system 8 also includes an HD (Hard Disk) 804 that stores various data and programs such as a management program and an HDD (Hard Disk Drive) 805 that controls reading/writing of various data from/to the HD 804 under control of the CPU 801. The management system 8 also includes a medium I/F (interface) 807 for controlling reading/writing (storage) of data from/to a medium 806 such as a flash memory; a display 808 for displaying various types of information, such as a cursor, a menu, a window, characters, images, and the like; and a network I/F 809 for establishing data communication using the communication network N. The management system 8 further includes a keyboard 811 including a plurality of keys for inputting characters, numeric values, and various instructions; a mouse 812 for selecting and executing various instructions, selecting an object to be processed, moving a cursor, and the like; a CD-ROM drive 814 for controlling reading/writing of various data from/to a CD-ROM (Compact Disc Read Only Memory) 813 as an example of a removable recording medium; and a bus line 810, such as an address bus or a data bus, for electrically connecting the above hardware elements.

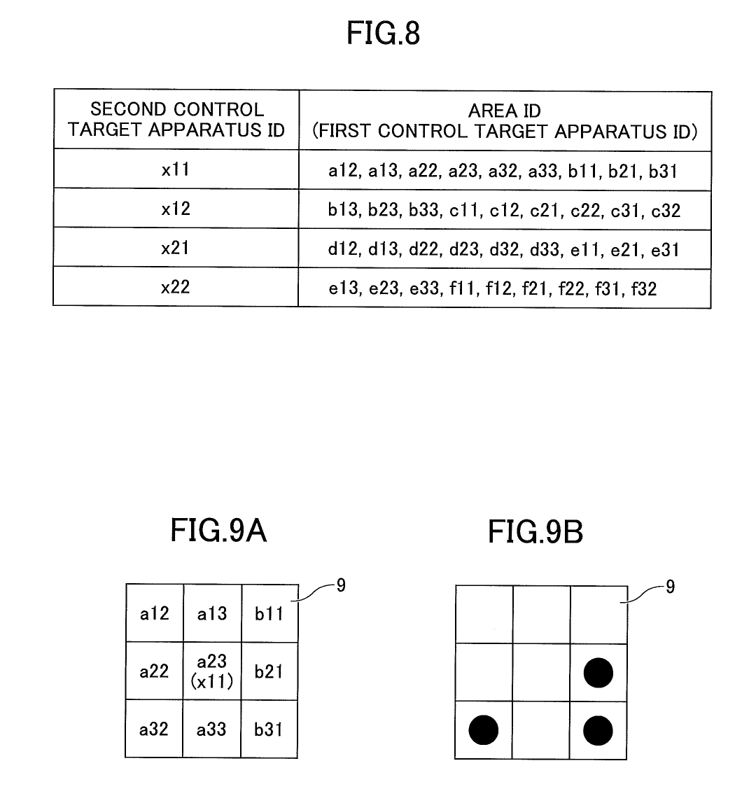

Note that the hardware elements of the management system 8 illustrated in FIG. 8 do not necessarily have to be provided within one housing or provided as a unitary device. That is, FIG. 8 merely indicates hardware elements that are preferably included in the management system 8. Also, certain functions of the management system 8 may be allocated to cloud computing, for example, such that the physical configuration of the management system 8 of the present embodiment need not be fixed but may be dynamically changed by connecting/disconnecting hardware resources according to the processing load, for example.

Also, note that the management program to be executed by the management system 8 may be stored in a storage medium, such as the medium 806 or the CD-ROM 813, in an executable format or a compressed format and distributed in such a state, for example. The management program may also be distributed by a program distributing server, for example.

<Functional Configuration of Device Control System>

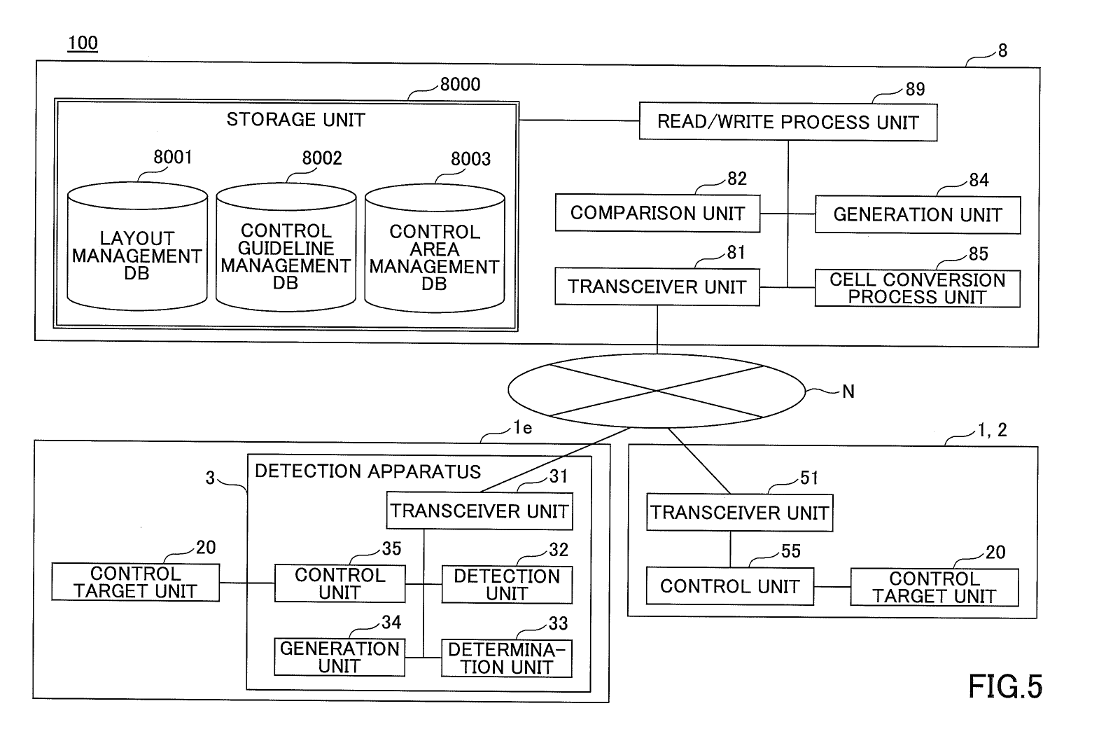

In the following, an example functional configuration of the device control system 100 is described with reference to FIG. 5. FIG. 5 is a block diagram illustrating example functional configurations of the first control target apparatus 1e including the detection apparatus 3, the first control target apparatus 1 without the detection apparatus 3, the second control target apparatus 2, and the management system 8 of the device control system 100.

<Functional Configuration of First Control Target Apparatus 1e>

The first control target apparatus 1e includes a control target unit 20 and functions of the detection apparatus 3. The detection apparatus 3 includes a transceiver unit 31, a detection unit 32, a determination unit 33, a generation unit 34, and a control unit 35. These functional units may be implemented by operations of the apparatus controller 315 of FIG. 3A outputting commands based on a program, for example. The control target unit 20 may be implemented by the LED lamp 130 that is subject to lighting control, for example.

The transceiver unit 31 of the detection apparatus 3 may be implemented by operations of the apparatus controller 315 and the wireless module 301 of FIG. 3A. For example, the transceiver unit 31 may exchange various types of data with the management system 8 via the communication network N.

The detection unit 32 may be implemented by operations of the temperature distribution sensor 311, the illuminance sensor 312, and the temperature and humidity sensor 313, for example. The detection unit 32 detects the temperature distribution, the illuminance, the temperature and humidity of each area 9 within a predetermined space.

The determination unit 33 may be implemented by operations of the apparatus controller 315. For example, the determination unit 33 may determine whether the temperature of the area 9 is within a predetermined range (e.g., 30° C. to 35° C.).

The generation unit 34 may be implemented by operations of the apparatus controller 315. For example, the generation unit 34 may generate heat source data indicating the presence or absence of a heat source based on a determination result of the determination unit 33.

The control unit 35 may be implemented by operations of the apparatus controller 315. For example, the control unit 35 may generate a control signal to be output to the control target unit 20 based on control data transmitted from the management system 8.

<Functional Configuration of First Control Target Apparatus 1 without Detection Apparatus/Second Control Target Apparatus 2>

In the following, functional configurations of the first control target apparatus 1 not having the detection apparatus 3 and the second control target apparatus 2 are described. The first control target apparatus 1 without the detection apparatus 3 and the second control target apparatus 2 include a transceiver unit 51, a control unit 55, and a control target unit 20. The transceiver unit 51 may be implemented by operations of the apparatus controller 315 and the wireless module 301, for example. The transceiver unit 51 exchanges various types of data with the management system 8 via the communication network N.

The control unit 55 may be implemented by operations of the apparatus controller 315, for example. The control unit 55 may generate a control signal to be output to the control target unit 20 based on control data transmitted from the management system 8, for example.

The control target unit 20 of the first control target apparatus 1 may be implemented by the LED lamp 130 that is subject to lighting control, for example. The control target unit 20 of the second control target apparatus 2 may be implemented by a heat pump and a compressor of an air conditioner, for example.

<Functional Configuration of Management System 8>

In the following, the functional configuration of the management system 8 is described. The management system 8 includes a transceiver unit 81, a comparison unit 82, a generation unit 84, a cell conversion process unit 85, and a read/write process unit 89. The above functional units may be implemented by operations prompted by commands from the CPU 801 based on a management program loaded from the HD 804 into the RAM 803 of FIG. 4, for example. Further, the management system 8 includes a storage unit 8000 that may be implemented by the RAM 803 and the HD 804 of FIG. 4, for example. The storage unit 8000 includes a layout management DB (database) 8001, a control guideline management DB 8002, and a control area management DB 8003. In the following, the above databases described.

(Layout Management DB)

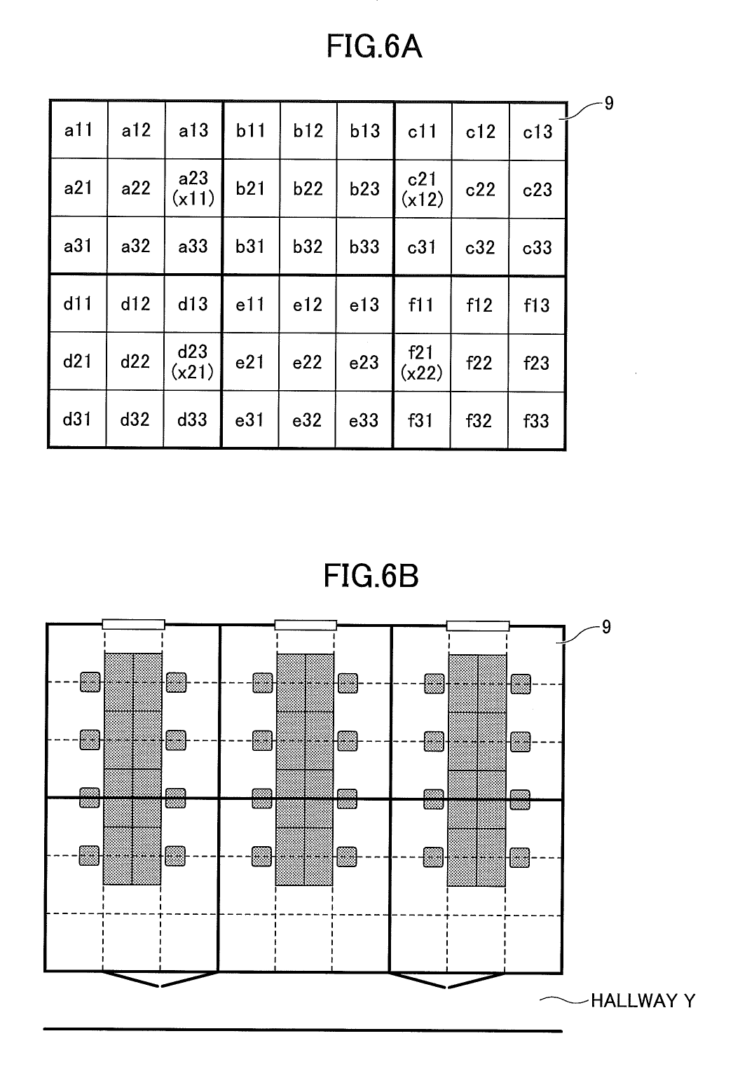

In the following, the layout management DB 8001 is described with reference to FIG. 6A. The layout management DB 8001 manages layout information of the first control target apparatus 1 and the second control target apparatus 2. FIG. 6A illustrates an example of layout information of the first control target apparatus 1 and the second control target apparatus 2.

In the example layout information illustrated in FIG. 6A, the room α is divided into 54 areas 9, and an apparatus ID identifying an LED lighting apparatus as an example of the first control target apparatus 1 is associated with each area 9. Note that in FIG. 6A, the apparatus ID is represented by a combination of an alphabet (a, b, c, d, e, or f) and a two-digit number that is indicated in each area 9. Among these apparatus IDs, the nine areas 9 on the upper left side of FIG. 6A having apparatus IDs starting with the alphabet “a” correspond to the nine areas 9 illustrated in FIG. 1. That is, FIG. 1 illustrates a part of the room α. The entire room α actually includes six blocks having apparatus IDs starting with a, b, c, d, e, and f. Each block is divided into nine areas 9 such that the entire room α includes a total of 54 areas 9. Note that the division of the room α into areas 9 as described above is merely one example, and a given space may be divided into any number of blocks, and a block may be divided into any number of areas, for example.

In the example layout information of FIG. 6A, a combination of the alphabet “x” and a two-digit number represents an apparatus ID identifying the second control target apparatus 2. Note that the second control target apparatus 2 illustrated next to the first control target apparatus 1f in FIG. 1 corresponds to the second control target apparatus 2 with the apparatus ID “x11” indicated in FIG. 6A. Although the second control target apparatuses 2 with the apparatus IDs “x12”, “x21”, “x22” are not illustrated in FIG. 1, they are installed on the ceiling β at the corresponding areas 9 of the room α as indicated in FIG. 6A. That is, in the present example, four air conditioners are installed on the ceiling β of the room α.

Note that an ID may be a name, a symbol, a character string, a numerical value, or a combination thereof used for uniquely distinguishing a specific object from a plurality of objects. The ID may also be called identification information or an identifier. Specific examples of an ID include but are not limited to a combination of serial numbers that do not overlap with a room number, a simple serial number, an apparatus serial number, and the like.

In the present embodiment, one first control target apparatus 1 is installed in each area 9, and as such, the apparatus ID of the first control target apparatus 1 is used as identification information for identifying the area 9.

FIG. 6B is a conceptual diagram of the layout information of the room α. FIG. 6B illustrates an example actual layout of the room α that is divided into areas 9 corresponding to the areas 9 of the layout information of FIG. 6A. The layout of FIG. 6B is divided into areas 9 by dashed lines and solid lines. FIG. 6B illustrates an actual layout in which desks and chairs are arranged. The layout of FIG. 6B is similarly divided into 54 areas 9 as in the layout information of the room α illustrated in FIG. 6A. That is, the positions of the areas 9 illustrated in FIG. 6B correspond to the positions of the areas 9 illustrated in FIG. 6A. In FIG. 6B, the lower side corresponds to a side toward a hallway Y, and the upper side corresponds to a side toward the window.

(Control Guideline Management DB)

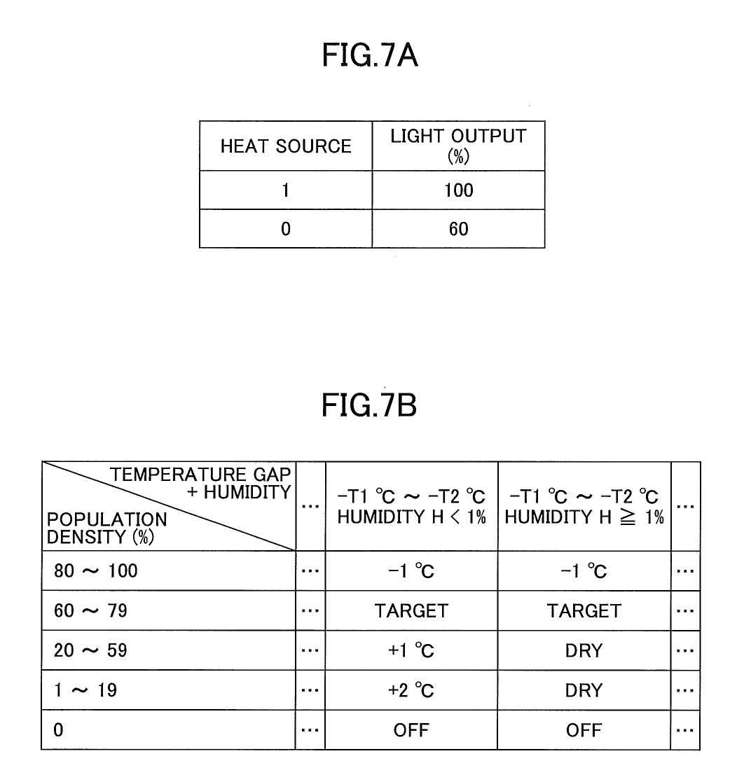

In the following, the control guideline management DB 8002 is described with reference to FIGS. 7A and 7B. The control guideline management DB 8002 manages a first control guideline management table as illustrated in FIG. 7A, for example. The first control guideline management table associates each heat source data field with corresponding control to be implemented with respect to the control target unit 20. For example, if the heat source data is “1”, this indicates that a heat source is present and that a person is present in the corresponding area 9. In this case, according to the first control guideline management table, the light output is to be controlled to 100% so as to maximize the amount of light output by the LED lamp 130 (control target unit 20) to thereby enable a person to work comfortably. On the other hand, if the heat source data is “0”, this indicates that there is no heat source and no one is present in the corresponding area 9. In this case, the light output of the LED lamp 130 (control target unit 20) is to be adjusted to 60% in order to promote energy conservation. Note that 100% is merely one example of a suitable amount of light to be output by the control target unit 20 for promoting comfort, and 60% is one example of a suitable amount of light to be output by the control target unit 20 for promoting energy conservation without making work difficult. In other examples, when the heat source data is “1”, the amount of light may be set to 90%, and when the heat source data is “0”, the amount of light may be set to 50%. That is, the amount of light may be set to any suitable amount as long as the amount of light to be output when the heat source data is “1” is higher than the amount of light to be output when the heat source data is “0”.

Also, in some embodiments, the control guideline management table may be set up with respect to each first control target apparatus 1 or each area 9, for example. In this way, the management system 8 may be able to control the first control target apparatuses 1 based on different control guidelines depending on the location of the first control target apparatuses 1, for example.

The control guideline management DB 8002 also manages a second control guideline management table as illustrated in FIG. 7B, for example. The second control guideline management table associates each population density range and each set of temperature gap+humidity with a corresponding control guideline for controlling air conditioning. Note that the temperature gap refers to the difference between the target temperature for the second control target apparatus 2 in controlling the temperature and the actual temperature detected by the temperature distribution sensor 311. According to the second control guideline management table of FIG. 7B, for example, when the population density is 1% to 19%, the temperature gap is in the range from −T1° C. to −T2° C. with respect to the target temperature, and the humidity is less than H1%, the second control target apparatus 2 is controlled to increase the temperature by +2° C. with respect to the target temperature. When the humidity is greater than or equal to H1% with the same temperature gap (−T1° C. to −T2° C.) and the same population density (1% to 19%), the second control target apparatus 2 is controlled to operate in dry mode.

As illustrated in FIG. 7B, a control guideline for controlling air conditioning may be set up with respect to each combination of temperature gap and humidity and with respect to each population density range. In this way, the management system 8 may be able to perform fine and detailed air conditioning control. For example, if the population density of an area 9 is relatively high, the temperature of the area 9 may increase due to the body heat of persons present in the area 9. Thus, the management system 8 may anticipate such a temperature increase and control the second control target apparatus 2 before any discomfort is felt by the persons present in the area 9, for example. That is, the management system 8 may implement feedforward control. In this way, comfort may be further improved.

Note that the manner in which the population density ranges are divided is merely one example, and the population density may be subdivided into finer ranges, or the population density ranges may be divided into unequal ranges, for example. Also, note that the manner in which the population density is calculated is described below with reference to FIGS. 9A and 9B.

(Control Area Management DB)

In the following, the control area management DB 8003 is described with reference to FIG. 8. The control area management DB 8003 manages a control area management table as illustrated in FIG. 8, for example. The control area management table manages the apparatus ID of each second control target apparatus 2 in association with corresponding area IDs. The area ID corresponds to the apparatus ID of the first control target apparatus 1. As can be appreciated from FIG. 6A, the apparatus ID of each second control target apparatus 2 is associated with the area IDs of a 3×3 block of areas 9 centered around the second control target apparatus 2 in the control area management table.

Note that the 3×3 block of areas 9 associated with the apparatus ID of each second control target apparatus 2 is merely one example, and in other examples, a 4×4 block of areas 9 or the like may be associated with the apparatus ID of each second control target apparatus 2, for example. Also, each area 9 may be associated with the second control target apparatus 2 that is closest thereto, for example. Note that in the present embodiment, one first control target apparatus 1 is associated with one area 9, and as such, a control area management table associating each first control target apparatus 1 with a corresponding area 9 is not necessary. However, in a case where a first control target apparatus 1 is used to detect the presence/absence of a heat source at an area 9 other than the area 9 directly below this first control target apparatus 1, a control area management table similar to that illustrated in FIG. 8 may be set up for the first control target apparatus 1, for example.

(Functional Units of Management System)

Referring back to FIG. 5, the functional units of the management system 8 are described below. The transceiver unit 81 receives detection data from the detection apparatus 3 and transmits control data to the detection apparatus 3, for example.

The comparison unit 82 compares the layout information as illustrated in FIG. 6A with heat source data as illustrated in FIG. 12 (described below), for example. In this way, the presence/absence of a person in each area 9 is determined.

The generation unit 84 refers to the comparison result of the comparison unit 82 and the first control guideline management table to generate control data indicating the light output (amount of light) for the first control target apparatus 1. Further, the generation unit 84 refers to the comparison result of the comparison unit 82 and the second control guideline management table to generate air conditioning control data for the second control target apparatus 2 based on heat source data and humidity data detected by the temperature and humidity sensor 313, for example.

The cell conversion process unit 85 converts the heat source data transmitted from the temperature distribution sensor 311 into heat source data for an area 9 of the room α. Note that the conversion process is described is described in detail below.

The read/write process unit 89 reads data from the storage unit 8000 or stores data in the storage unit 8000, for example.

<Population Density>

The population density is described below with reference to FIGS. 9A and 9B. FIG. 9A is an example diagram for describing the population density. In FIG. 9A, a 3×3 block of areas 9 is illustrated. The 3×3 block of areas 9 is set up in the control area management DB 8003 of the management system 8 as a range subject to air conditioning control (e.g., temperature and/or humidity control) by one second control target apparatus 2. The population density is calculated with respect to each range subject to air conditioning control by the second control target apparatus 2.

In FIG. 9B, black circles are indicated in areas 9 where the presence of a person is detected (areas where a heat source is detected). Because the presence of a person is detected in three of the nine areas 9, the population density is calculated as follows: (3÷9)×100=approximately 33%. Note that when the presence of a person is detected in a given area 9, the number of persons in that area 9 is counted as one regardless of the actual number of persons in that area 9.

The 3×3 block of areas 9 for which the population density is calculated corresponds to a range subject to air-conditioning control by one second control target apparatus 2. The detection apparatus 3 transmits temperature data and humidity data for each of the nine areas 9 to the management system 8. In turn, the management system 8 determines the average of the temperature data for the nine areas 9 as an environmental value (temperature) for the nine areas 9. With respect to the humidity, the management system 8 may set the humidity data detected by the detection apparatus 3 that is closest to the second control target apparatus 2 as an environmental value (humidity) for the nine areas 9, or obtain the average of the humidity data detected by two or more detection apparatuses 3 as the environmental value (humidity) for the nine areas 9.

<Operation Procedure>

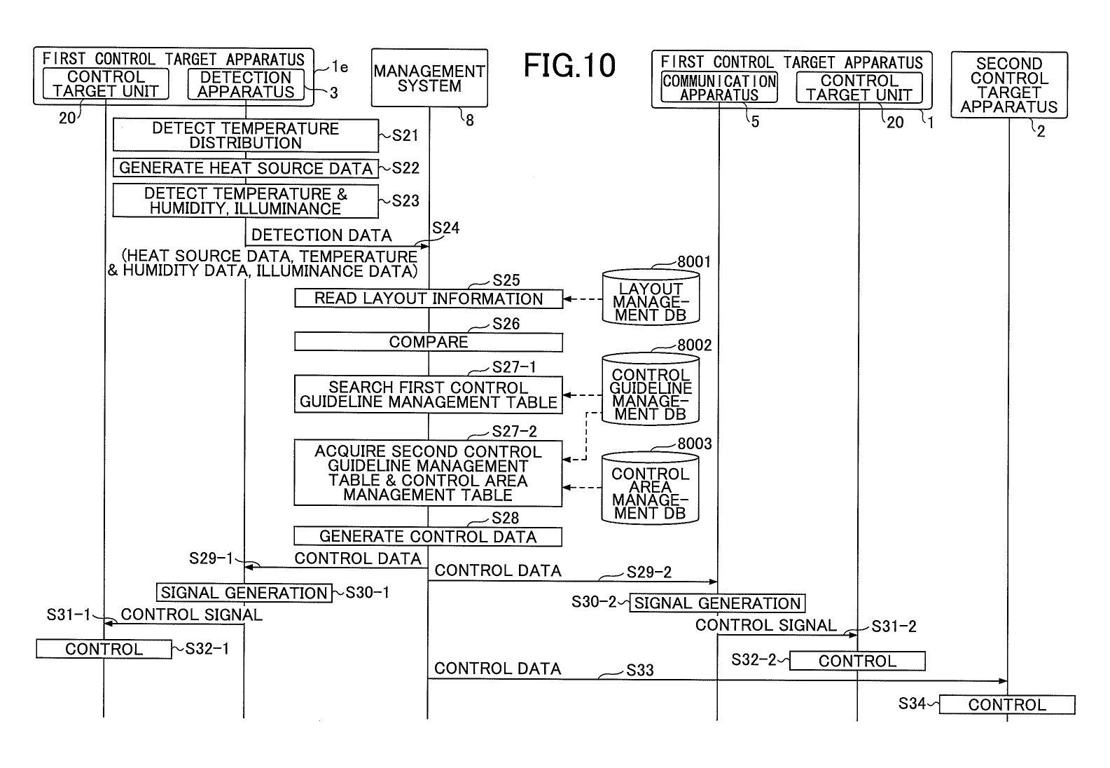

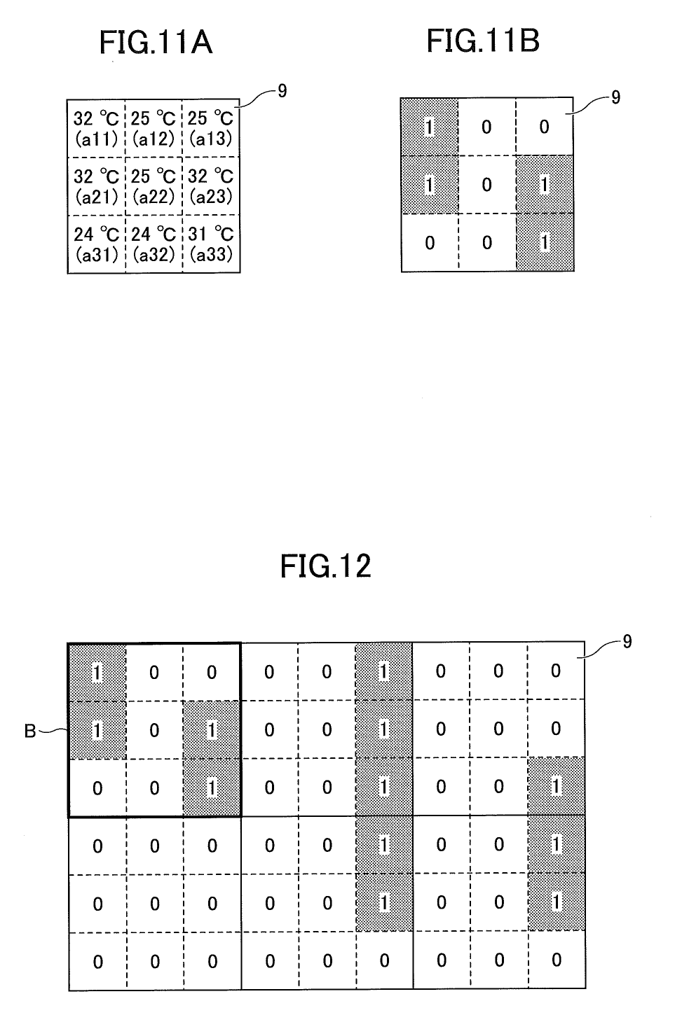

In the following, processes or operations of the management system 8 are described with reference to FIGS. 10-12. FIG. 10 is a sequence chart illustrating an example process implemented by the management system 8. FIG. 11A is a conceptual diagram of a temperature distribution detected by the temperature distribution sensor 311, and FIG. 11B is a conceptual diagram of heat source data indicating the presence/absence of a heat source. FIG. 12 is a conceptual diagram of heat source data indicating the presence/absence of a heat source in all the areas 9 of the room α.

In the present example process, the management system 8 generates control data for controlling the first control target apparatus 1 and the second control target apparatus 2 based on various data detected by the first control target apparatus 1e and transmits the generated control data to the first control target apparatus 1 and the second control target apparatus 2 to cause the first control target apparatus 1 and the second control target apparatus 2 to perform lighting control and air conditioning control. In the following, in order to simplify the description, processes implemented by the first control target apparatus 1e including the detection apparatus 3 and some other first control target apparatus 1 of the plurality of first control target apparatuses 1, and the second control target apparatus 2 will be described.

In step S21, the detection unit 32 of the first control target apparatus 1e detects the temperature distribution of the areas 9 within the room α.

Then, in step S22, the determination unit 33 determines, with respect to each area 9, whether the temperature of the area 9 is within a predetermined range (e.g., 30° C. to 35° C.), and the generation unit 34 generates heat source data based on the determination result.

In the following, the process of generating the heat source data is described with reference to FIGS. 11A and 11B. FIG. 11A illustrates an example temperature distribution of nine areas 9 detected by the detection unit 32. Based on the detected temperature distribution as illustrated in FIG. 11A, the generation unit 34 generates heat source data as illustrated in FIG. 11B, for example. As can be appreciated, the heat source data of FIG. 11B is represented by heat source presence/absence information indicating whether a heat source is present in each area 9. Specifically, an area 9 where the detected temperature is within a predetermined range (e.g., 30° C. to 35° C.) is represented by “1” indicating that a heat source is present, and an area 9 where the detected temperature is outside the predetermined temperature range (e.g., below 30° C. or above 35° C.) is represented by “0” indicting that a heat source is not present.

Referring back to FIG. 10, in step S23, the detection unit 32 of the first control target apparatus 1e detects the illuminance, the temperature, and the humidity near the first control target apparatus 1e.

Then, in step S24, the transceiver unit 31 of the first control target apparatus 1e transmits detection data to the management system 8. The detection data includes the heat source data generated in step S22, temperature and humidity data (including temperature data used for generating the heat source data) and illuminance data indicating the detection results obtained in step S23. As a result, the transceiver unit 81 of the management system 8 receives the detection data. Note that the temperature data used for generating the heat source data is preferably temperature data for each detection cell, but the temperature data used may also be an average of the temperatures of some or all of the areas 9, for example. In this way, the load on the management system 8 may be prevented from increasing, for example. In this case, the temperatures of the areas 9 may be regarded as the same, for example.

FIG. 12 illustrates an example of heat source data obtained by synthesizing heat source data transmitted from a plurality of first control target apparatuses 1 including the detection apparatus 3. FIG. 12 is a conceptual diagram of heat source data indicating the presence/absence of a heat sources in all the areas 9 within the room α. The heat source data illustrated in FIG. 11B corresponds to the heat source data of block B on the upper left portion of FIG. 12.

In step S25, the read/write process unit 89 of the management system 8 reads out the layout information as illustrated in FIG. 6A from the layout management DB 8001, for example.

Then, in step S26, the comparison unit 82 compares the layout information of FIG. 6A with the heat source data of FIG. 12. By comparing the layout information and the heat source data, for example, it can be determined that a heat source is present in the area 9 of the layout information where the first control target apparatus 1a is installed (with the area ID “a11”) based on the value “1” indicated as the heat source data for the corresponding area 9.

Then in step S27-1, the read/write process unit 89 of the management system 8 uses the values “1” and “0” indicating the presence/absence of a heat source of the heat source data as search keys to search for a corresponding light output (amount of light) from the first control guideline management table of the control guideline management database 8002 and reads the corresponding light output.

Then, in step S27-2, the read/write process unit 89 of the management system 8 reads (acquires) the second control guideline management table from the control guideline management DB 8002 and reads (acquires) the control area management table from the control area management DB 8003.

Then, in step S28, the generation unit 84 generates control data indicating the light output (amount of light) for the first control target apparatus 1. Further, the generation unit 84 generates control data for the second control target apparatus 2. In this way, based on one set of detection data transmitted in step S24 (based on the same detection data), both control data for the first control target apparatus 1 and control data for the second control target apparatus 2 may be generated. Thus, in a case where both the first control target apparatus 1 and the second control target apparatus 2 are controlled, the number of times the detection apparatus 3 performs detection and the number of time the management system 8 receives detection data may be reduced by half, for example. Also, by using the same detection data, consistency of the operations of the first control target apparatus 1 and the second control target apparatus 2 may be easily achieved, for example.

Then, in steps S29-1 and S29-2, the transceiver unit 81 of the management system 8 transmits corresponding control data to each of the first control target apparatuses 1. In turn, the transceiver unit 31 of the first control target apparatus 1e receives the control data. Also, the transceiver unit 51 of the first control target apparatus 1 other than the first control target apparatus 1e receives the control data.

Then, in steps S30-1 and S30-2, the control unit 35 of the first control target apparatus 1e generates a control signal to be output to the control target unit 20 implemented by the LED lamp 130 based on the received control data. Similarly, the control unit 55 of the first control target apparatus 1 other than the first control target apparatus 1e generates a control signal to be output to the control target unit 20 implemented by the LED lamp 130 based on the received control data.

Then, in steps S31-1 and S31-2, the control unit 35 outputs the generated control signal to the control target unit 20. The control unit 55 outputs the generated control signal to the control target unit 20.

Then, in steps S32-1 and S32-3, the amount of light output by each LED lamp 130 as the control target unit 20 is controlled based on the control signal.

In step S33, the transceiver unit 81 of the management system 8 transmits control data to the second control target apparatus 2. In turn, the transceiver unit 51 of the second control target apparatus 2 receives the control data.

In step S34, based on the received control signal, the temperature, the humidity, the air volume, and the air flow direction of the air conditioner as the control target unit 20 are controlled.

For example, based on FIGS. 11A and 11B, it can be determined that there is no heat source in the area 9 having the area ID “a22” (because “0” is indicated as the heat source data for the corresponding area 9). Thus, based on the first control guideline management table of FIG. 8A, the amount of light to be output by the first control target apparatus 1 installed in the area 9 with the area ID “a22” is controlled to 60%. On the other hand, according to FIGS. 11A and 11B, a heat source is present directly below the area 9 with the area ID “a21” (because “1” is indicated as the heat source data for the corresponding area 9). Thus, based on the first control guideline management table of FIG. 8A, the amount of light to be output by the first control target apparatus 1 installed in the area 9 with the area ID “a21” is controlled to 100%.

In this way, when a heat source is detected due to the presence of a person, the light output of the LED lamp may be set to a maximum value, and when a heat source is not detected due to the absence of a person, the light output of the LED lamp may be lowered to thereby realize energy conservation, for example. Also, because the amount of light to be output is increased when a person is present, comfort may be improved, for example.

<Determination of Presence/Absence of Heat Source>

In the following, three different patterns of as example methods for determining the presence/absence of a heat source in step S22 of FIG. 10 are described.

(Pattern 1)

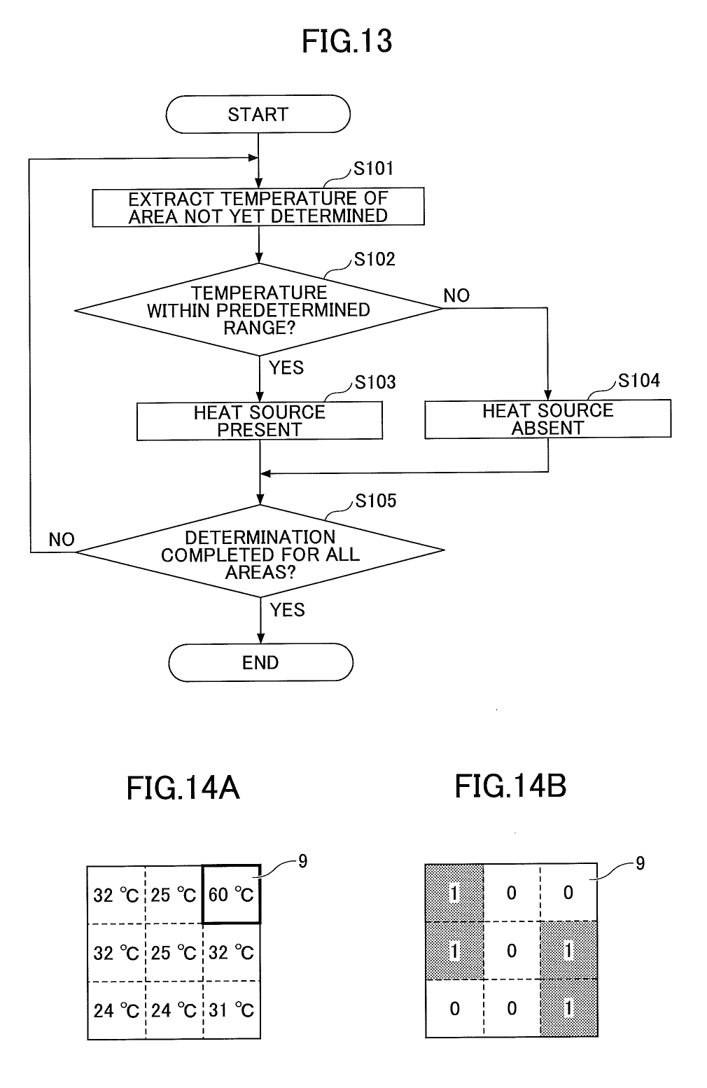

FIG. 13 is a flowchart illustrating an example method of generating heat source data. FIG. 14A is an example conceptual diagram of temperature distribution data, and FIG. 14B is an example conceptual diagram of heat source data indicating the presence/absence of a heat source.

First, in step S101, the generation unit 34 of the management system 8 extracts, from the temperature distribution data, an area 9 for which the determination unit 33 has not yet determined whether a corresponding temperature is within a predetermined range (e.g., 30° C. to 35° C.).

Then, in step S102, the determination unit 33 determines whether the temperature of the area 9 extracted in step S101 is within the predetermined range. For example, referring to FIG. 14A, when an electric pot (water heater) is installed in the area 9 where the first control target apparatus 1 with the apparatus ID “a13” is installed, steam or heat emitted by the electric pot may cause the temperature of this area 9 to rise to 60° C., for example. In such a case, even if a heat source is present, the temperature of the heat source is not within the range of a heat source corresponding to a human being (e.g., 30° C. to 35° C.), and as such, the determination unit 33 preferably does not detect that a person is present.

When the determination unit 33 determines in step S102 that the temperature of the extracted area 9 is within the predetermined range (YES in step S102), the determination unit 33 determines that a heat source is present (step S103). In this case, as illustrated in FIG. 14B, “1” indicating that a heat source is present is set up as the heat source data for the extracted area 9.

On the other hand, if the determination unit 33 determines that the temperature of the extracted area 9 is not within the predetermined range (NO in step S102), the determination unit 33 determines that no heat source is present (step S104). In this case, as illustrated in FIG. 14B, “0” indicating that there is no heat source is set up as the heat source data for the extracted area 9.

After executing the process of step S103 or step S104, the determination unit 33 determines whether the determination of whether a temperature of an area 9 is within the predetermined range has been completed with respect to all the areas 9 (step S105). If it is determined in step S105 that the determination has been completed with respect to all the areas 9 (YES in step S105), the process of step S22 of FIG. 10 is ended. On the other hand, if it is determined in step S105 that the determination has not yet been completed with respect to all the areas 9 (NO in step S105), the process returns to step S101.

As described above, according to the process illustrated in FIG. 13, even when a heat source is present, if the temperature of the heat source is outside the temperature range of a specific object (e.g., human being) to be detected as a heat source, it is assumed that no heat source is present. In this way, the presence of a human being may be more accurately detected, and as a result, energy conservation may be more accurately implemented.

(Pattern 2)

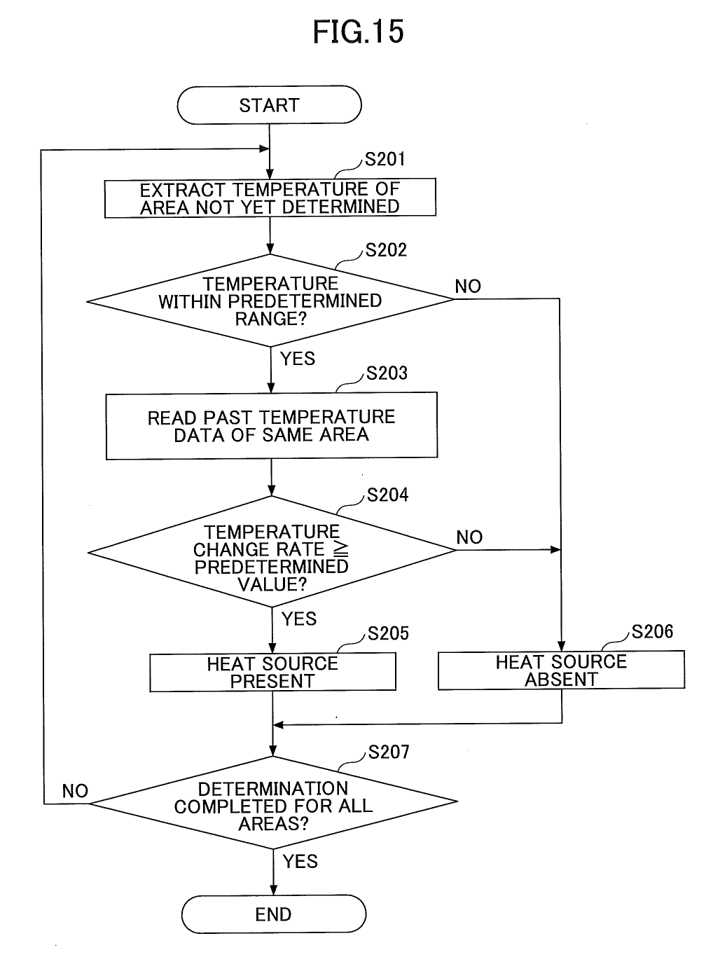

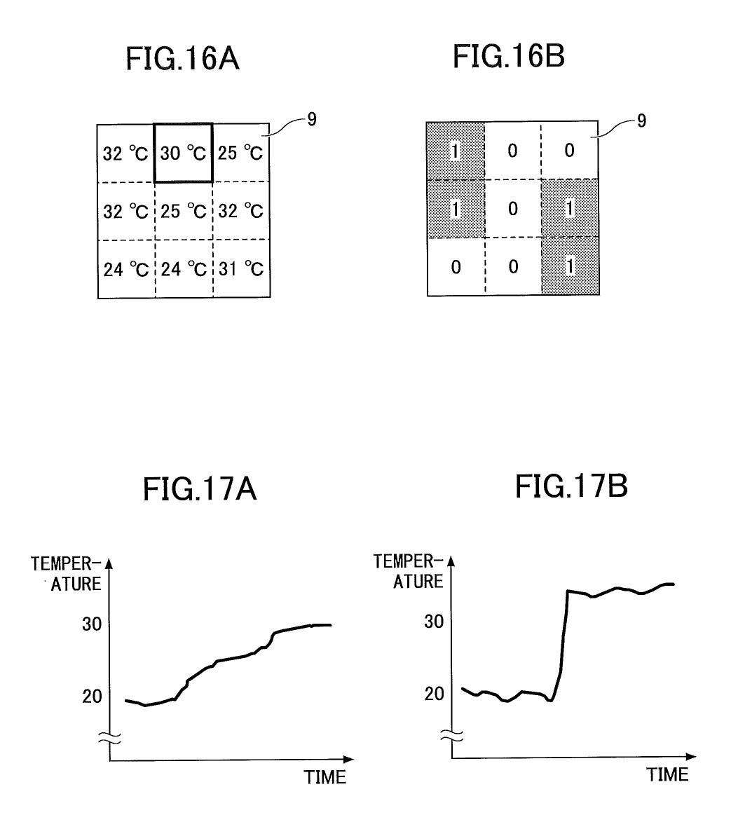

FIG. 15 is a flowchart illustrating another example method of generating heat source data. FIG. 16A is another example conceptual diagram of temperature distribution data, and FIG. 16B is another example conceptual diagram of heat source data indicating the presence/absence of a heat source. FIGS. 17A and 17B are graphs indicating temperature changes in a given area 9.

Note that steps S201, S202, S205, S206, and S207 of FIG. 15 respectively correspond to steps S101, S102, S103, S104, and S105 of FIG. 13, and as such, descriptions of these process steps are omitted. In the following, the processes of steps S203 and S204 of FIG. 15 are described. In the present example, the detection unit 32 of the detection apparatus 3 is configured to store detection data of each sensor for a certain period of time (e.g., 10 minutes).

In step S202, the determination unit 33 determines whether the temperature of an area 9 is within a predetermined range. When the determination unit 33 determines that the temperature of the area 9 is within the predetermined range (YES in step S202), the determination unit 33 reads past temperature data indicating the past temperature of the same area 9 that is stored in the detection unit 32 (step S203).

Then, in step S204, the determination unit 33 determines whether the temperature change rate of the area 9 is greater than or equal to a predetermined value (e.g., whether the temperature increases by 5° C. or more within 10 seconds). For example, as illustrated in FIG. 16A, the temperature of the area 9 with the apparatus ID (area ID) “a12” that is located near a window may rise during the day to be higher than the temperatures of the surrounding areas 9, for example. As a result, the temperature of the area 9 with the apparatus ID “a12” may be close to that of a human being. In such case, despite the absence of a human being, the presence of a human being may be erroneously detected, for example. Accordingly, in the present example, the determination unit 33 checks the past temperature data of the area 9. If the temperature of the area 9 has gradually increased as illustrated in FIG. 17A, for example, the determination unit 33 determines that the temperature change has been caused by sunlight, not a human being. On the other hand, if the temperature of the area 9 has suddenly increased as illustrated in FIG. 17B, for example, the determination unit 33 can infer that the temperature has suddenly increased as a result of a person entering the area 9. As such, the determination unit 33 may determine that a heat source corresponding to a human being is present in the area 9.

If the determination unit 33 determines in step S204 that the temperature change rate is greater than or equal to the predetermined value, the determination unit 33 determines that a heat source is present (step S205).

On the other hand, if the determination unit 33 determines in step S204 that the temperature change rate is not greater than or equal to the predetermined value, the determination unit 33 determines that no heat source is present (step S206). In this way, even if the temperature of a certain area 9 is 30° C. as illustrated in FIG. 16A, for example, under certain circumstances, “0” indicating that a heat source is not present may be set up as the heat source data for the area 9 as illustrated in FIG. 16B, for example.

As described above, according to pattern 2, even if the temperature of a certain area 9 is within the temperature range of a human being, if the temperature of the area 9 has gradually changed to fall within the predetermined range, the determination unit 33 may infer that the area 9 is merely located close to a window, for example, and that a human being is not actually present in the area 9. Thus, in such case, the determination unit 33 may determine that no heat source is present and thereby accurately detect the presence/absence of a human being. In this way, energy conservation may be more accurately implemented, for example.

(Pattern 3)

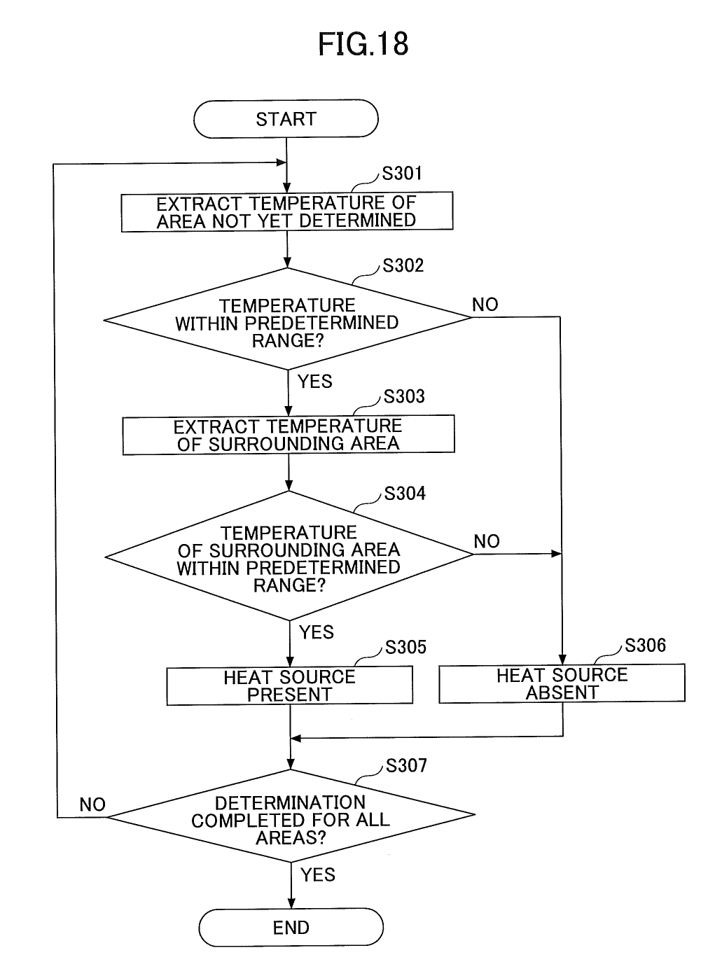

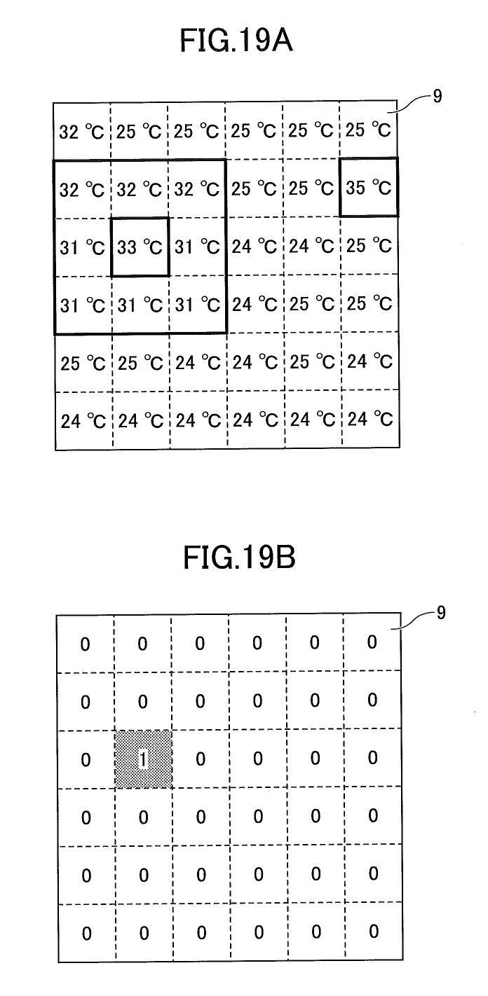

FIG. 18 is a flowchart illustrating another example method of generating heat source data. FIG. 19A is another example conceptual diagram of temperature distribution data, and FIG. 19B is another example conceptual diagram of heat source data indicating the presence/absence of a heat source.

Note that steps S301, S302, S305, S306, and S307 of FIG. 18 respectively correspond to steps S101, S102, S103, S104, and S105 of FIG. 13, and as such, descriptions of these process steps are omitted. In the following, the processes of steps S303 and S304 of FIG. 18 are described. In the present example, it is assumed that the detection unit 32 performs detection (acquires detection data) with respect to a 6×6 block of areas 9 as one block. Also, in the present example, one area 9 may be a 35 cm×35 cm square area, for example.

In step S302, the determination unit 33 determines whether the temperature of an extracted area 9 is within a predetermined range. When the determination unit 33 determines that the temperature of the extracted area 9 is within the predetermined range (YES in step S302), the determination unit 33 extracts the temperatures of surrounding areas 9 of the extracted area 9 from the temperature distribution data (step S303).

Then, in step S304, the determination unit 33 determines whether the temperatures of the surrounding areas 9 are within the same predetermined range (predetermined range used in the determination step S302). For example, there may be a cup of coffee that is getting cold in the room α and the temperature thereof may be 35° C., for example, which is close to the temperature of a human being. In such case, despite the absence of a human being, the presence of a human being may be erroneously detected. In this respect, a human being most likely takes up multiple areas 9 rather than one single area 9, whereas a cup of coffee most likely takes up only one single area 9. Accordingly, in the present example, the detection unit 33 checks the temperatures of the surrounding areas 9 and if the temperatures of the surrounding areas 9 are also within the predetermined range, the determination unit 33 determines that a heat source is present. On the other hand, if the temperatures of the surrounding areas 9 are outside the predetermined range, the determination unit 33 determines that no heat source is present.

For example, referring to the temperature distribution data of a 6×6 block of areas 9 as illustrated in FIG. 19A, because the temperature of the area 9 on the third row second column of the block is 33° C., and the temperatures of the eight areas 9 surrounding this area 9 are also within the predetermined range, the determination unit 33 determines that a heat source is present in this area 9. On the other hand, although the temperature of the area 9 on the second row sixth column of the block is 35° C., because the temperatures of the five areas 9 surrounding this area 9 are outside the predetermined range, the determination unit 33 determines that no heat source is present in this area 9. As a result, as shown in FIG. 19B, “1” indicating that a heat source is present is set up as the heat source data for the corresponding area 9 on the third row second column of the block, and “0” indicating that no heat source is present is set up as the heat source data for the corresponding area 9 on the second row sixth column of the block.

If the determination unit 33 determines in step S304 that the temperature of the surrounding areas 9 are within the predetermined range, the determination unit 33 determines that a heat source is present (step S305).

On the other hand, if the determination unit 33 determines in step S304 that the temperatures of the surrounding areas 9 are outside the predetermined range, the determination part 33 determines that no heat source is present (step S306). In this way, even though the area 9 on the second row sixth column is indicates as being 35° C. in the temperature distribution data of FIG. 19A, “0” indicating that no heat source is present is set up as the heat source data for the corresponding area 9 in the heat source data illustrated in FIG. 19B.

As described above, according to pattern 3, even if the temperature of an area 9 is within the temperature range of a human being, if the temperature does not extend across a sufficiently large area range, the determination unit 33 may infer that the heat source is not a human being but a small object such as a coffee cup or a warmer and that no human being is present. In such case, the determination unit 33 may determine that no heat source is present and thereby accurately detect the presence/absence of a human being. In this way energy conservation may be more accurately implemented, for example.

<Correlation Between Heat Source Data and Area>

Although the heat source data as illustrated in FIG. 12 is obtained in the manner described above, the shape of each cell of the heat source data may actually be distorted depending on the mounting angle of the temperature distribution sensor 311, for example, and the following inconvenience may occur as a result.

Note that the temperature of each area 9 can be detected with higher accuracy as the number of the temperature distribution sensors 311 is increased. However, increasing the number of the temperature distribution sensors 311 leads to a cost increase. In this respect, a plurality of temperature distribution sensors 311 may be installed in one first control target apparatus 1. However, in this case, the temperature distribution sensors 311 have to be inclined relative to the floor surface rather than being installed perpendicular to the floor surface. That is, because a plurality of the temperature distribution sensors 311 have to be installed within a limited area that is integrated with or is in the vicinity of the first control target apparatus 1, a temperature detection range 501 of a given temperature distribution sensor 311 cannot be adequately enlarged unless the temperature distribution sensor 11 is installed at an inclined angle.

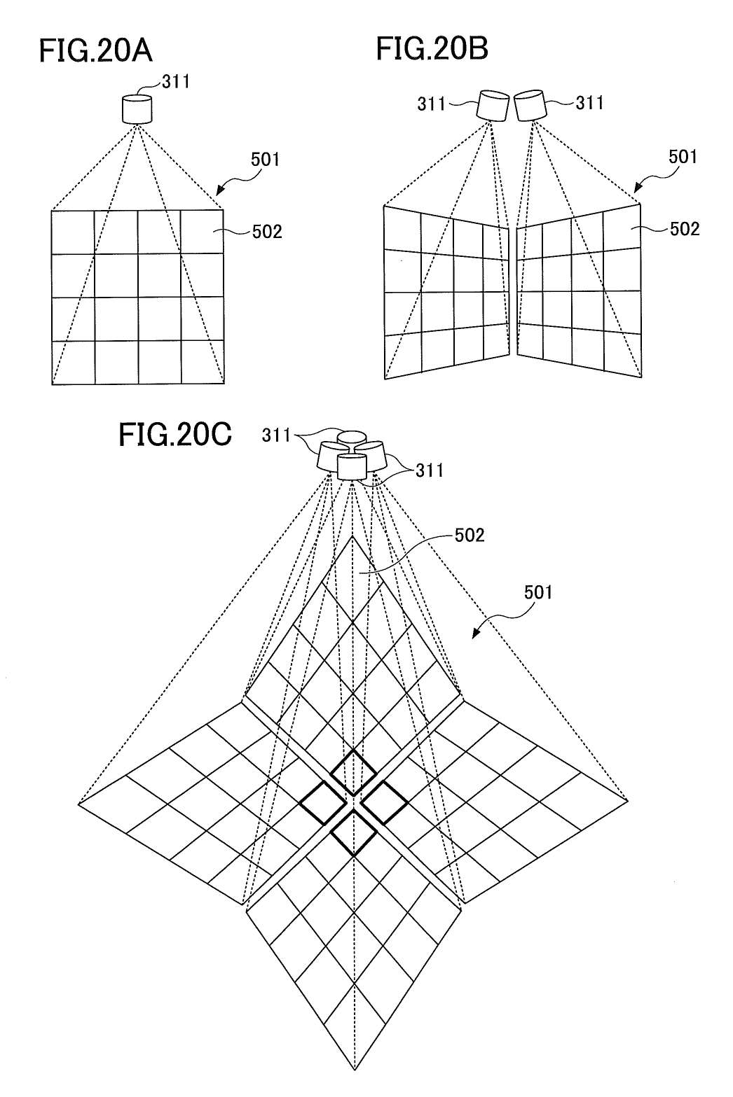

FIGS. 20A-20C are diagrams describing example relationships between the number of temperature distribution sensors 311 and their corresponding detection ranges 501. In FIG. 20A, one temperature distribution sensor 311 is installed perpendicular to the floor surface, and as such, the shape of the detection range 501 of the temperature distribution sensor 311 is a square (or a rectangle). In FIG. 20B, two temperature distribution sensors 311 are installed at inclined angles with respect to the floor surface, and as such, the shapes of the detection ranges 501 of the two temperature distribution sensors 311 are distorted into trapezoidal shapes due to trapezoidal distortion. In FIG. 20C, four temperature distribution sensors 311 are installed at inclined angles with respect to the floor surface, and as such, the shapes of the detection ranges 501 of the four temperature distribution sensors 311 are distorted into rhomboidal shapes (diamond shapes) with one diagonal line of a square being extended.

On the other hand, the room α is divided into a plurality of areas 9 that are squares or rectangles. Thus, when a plurality of temperature distribution sensors 311 are installed in one first control target apparatus 1, heat source data in distorted shapes have to be correlated with the areas 9 within the room α.

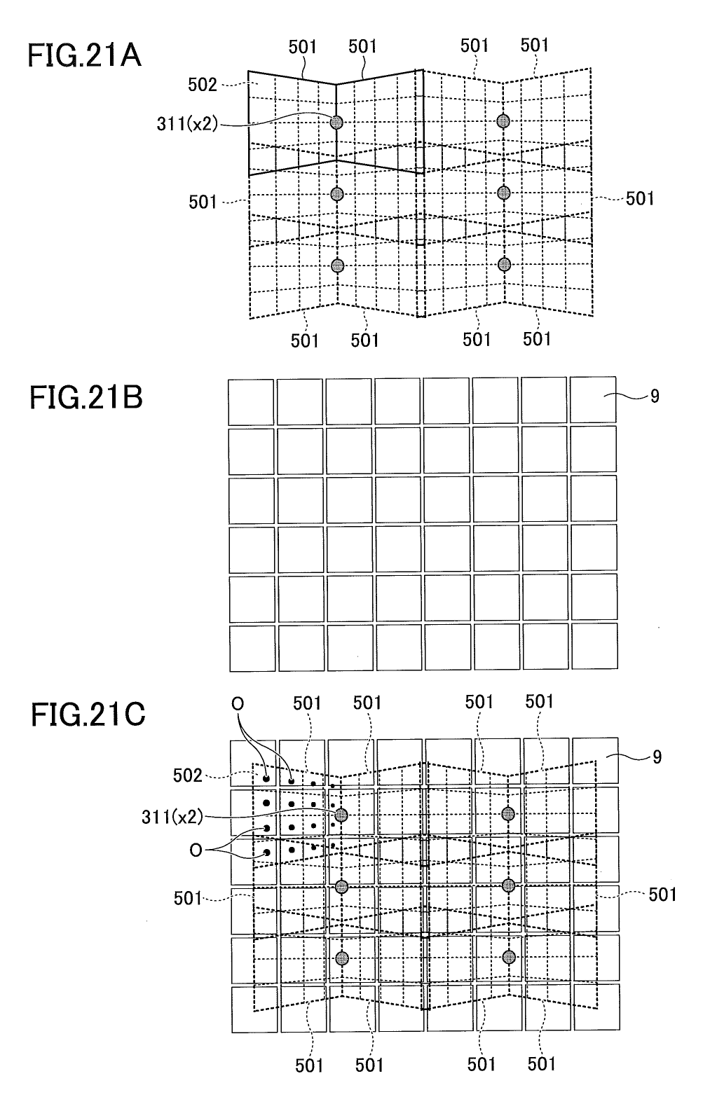

FIG. 21A illustrates the detection ranges 501 that can be detected by two temperature distribution sensors 311 that are installed in each first control target apparatus 1. Note that FIG. 21A illustrates an example case where a total of six first control target apparatuses 1 are provided and two temperature distribution sensors 311 are installed in each of the six first control target apparatuses 1. Further, each temperature distribution sensor 311 includes 4×4 thermopile sensors. That is, one temperature distribution sensor 311 can detect 16 temperatures in parallel. Note that in the following, a detection range of one thermopile sensor (as an example of a sensor detection range) is referred to as “detection cell 502”.

Because the temperature distribution sensors 311 are not installed perpendicular to the floor surface, the corresponding detection ranges 501 and detection cells 502 are distorted into trapezoidal shapes. Thus, the heat source data transmitted from the detection apparatus 3 to the management system 8 also reflects such distorted shapes. For this reason, it is difficult to use the heat source data distorted into trapezoidal shapes as is to represent the temperature of each area 9 of the room α. Accordingly, for example, the heat source data may be converted into a shape without distortions as illustrated in FIG. 21B. Alternatively, the presence/absence of a heat source indicated by each detection cell 502 of the heat source data may be correlated with a corresponding area 9 of the room α, for example. That is, the plurality of squares indicated in FIG. 21B represent the plurality of areas 9 within the room α.

FIG. 21C is a diagram in which FIG. 21A is superimposed on FIG. 21B. The cell conversion process unit 85 of the management system 8 correlates each area 9 of FIG. 21B with a corresponding detection cell 502 of FIG. 21A, and sets up each area 9 in association with heat source data (indicating presence/absence of a heat source) of the detection cell 502 detected by the corresponding thermopile sensor of the area 9. Note that one area 9 may is not necessarily be limited to including only one detection cell 502. In a case where a given area 9 is correlated with a plurality of detection cells 502, the logical sum of the heat source data indicating the presence/absence of a heat source is set up for the area 9.

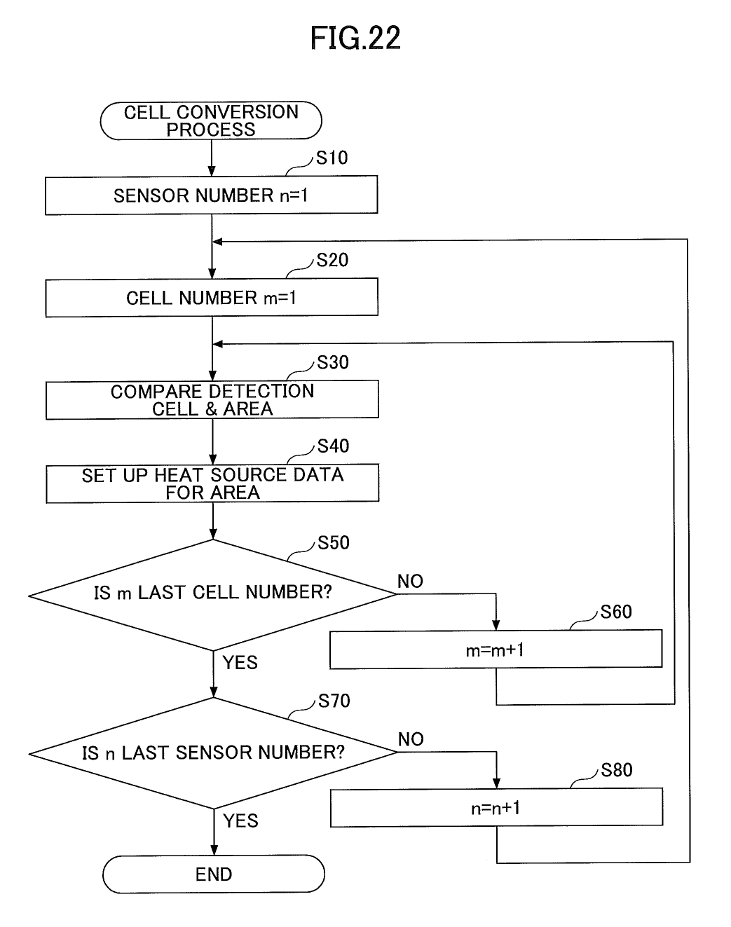

FIG. 22 is a flowchart illustrating an example process implemented by the cell conversion process unit 85 of the management system 8 for correlating a detection cell 502 of the detection range 501 with a corresponding area 9.

First, in step S10, the cell conversion process unit 85 sets the value “1” to “n”, which represents a sensor number of a temperature distribution sensor 311. The sensor number “n” is a serial number assigned to each of the temperature distribution sensors 311 and is used to specify a temperature distribution sensor 311 of interest.

Then, in step S20, the cell conversion process unit 85 sets the value “1” to “m”, which represents a cell number of a detection cell 502. The cell number “m” is a serial number assigned to each of the detection cells 502 of the plurality of thermopile sensors included in one temperature distribution sensor 311 and is used to specify a detection cell 502 of a thermopile sensor of interest.

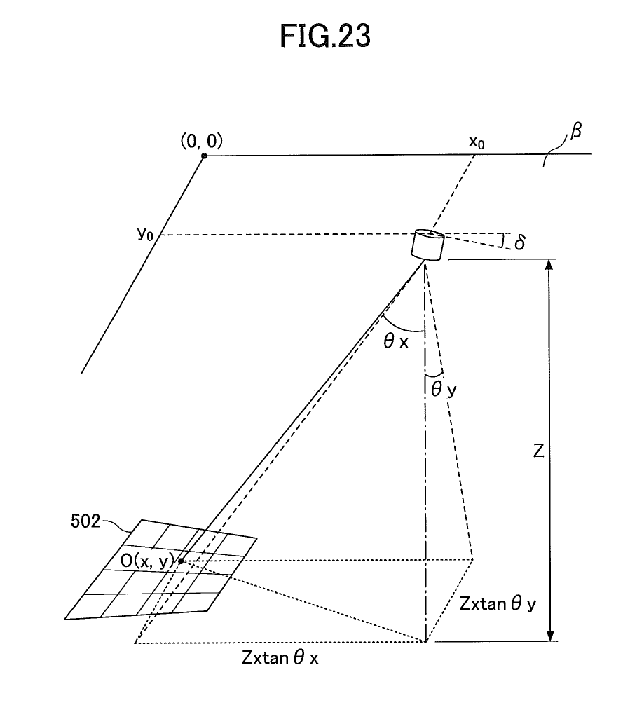

Then, in step S30, the cell conversion process unit 85 determines a corresponding area 9 overlapping with the detection cell 502 of the thermopile sensor of interest. This determination is made based on whether center coordinates O (see FIG. 21C) of the detection cell 502 of the thermopile sensor of interest is included within a given area 9. Note that the center coordinates O is described below with reference to FIG. 23.

Then, in step S40, the cell conversion process unit 85 sets up the heat source data (indicating the presence/absence of a heat source) of the detection cell 502 of interest in a corresponding area 9 that has been correlated with the detection cell 502 of interest in step S30.

Then, in step S50, the cell conversion process unit 85 determines whether the current value of “m” corresponds to the last cell number. If a negative determination (NO) is made in step S50, the cell conversion process unit 85 increments the value of “m” by 1 in step S60. Then, the cell conversion process unit 85 repeats steps S30-S50.

If a positive determination (YES) is made in step S50, the cell conversion process unit 85 determines whether the current value of “n” corresponds to the last sensor number (S70). If a negative determination (NO) is made in step S70, the cell conversion process unit 85 increments the value of “n” by 1 in step S80. Then, the cell conversion process unit 85 repeats steps S20-S70. If a positive determination (YES) is made in step S70, the process of FIG. 22 is ended.

The process of FIG. 22 for correlating an area 9 with a corresponding detection cell 502 may be performed by the management system 8 or the detection apparatus 3, for example. In this way, a table indicating the correlation between a cell number m and a sensor number n may be created. Thus, after the first control target apparatus 1e is installed on the ceiling β, the cell conversion process unit 85 can refer to such a table to acquire heat source data and the temperature of an area 9, for example.

FIG. 23 is a diagram describing the center coordinates O of a detection cell 502 of a thermopile sensor. In FIG. 23, coordinates (x₀, y₀) are assigned to a position of a thermopile sensor with respect to a corner of the ceiling β as the origin (0, 0), for example. Also, height Z is assigned as the height of the ceiling β. Further, it is assumed that the thermopile sensor is installed at inclination angles θx and θy with respect to the floor surface. Note that θx represents an inclination angle in the X direction, and θy represents an inclination angle in the Y direction.

Based on the above, the center coordinates O of the detection cell 502 of a thermopile sensor may be obtained by (x₀-Z tan θx, y₀-Z tan θy). The inclination angles θx and θy may be determined based on an installation angle δ of the detection apparatus 3 with respect to the first control target apparatus 1 and an angle of a central detection direction (central angle) of a detection direction range of the thermopile sensor (central angle when the thermopile sensor is installed perpendicular to an installation surface) that is provided by the manufacturer of the thermopile sensor, for example. That is, because the central angle of the detection direction range of each thermopile sensor may be provided by the manufacturer of the thermopile sensor, the inclination angles θx and θy may be obtained by adding together the central angle and the installation angle δ of the detection apparatus 3 with respect to the first control target apparatus 1. Note that in FIG. 23, the illustrated inclination angles θx and θy include the installation angle δ. The position (x₀, y₀) of the thermopile sensor, the inclination angles θx and θy, and the installation angle δ correspond to information relating to the position of the detection cell 502 formed by the thermopile sensor.

Because the areas 9 are obtained by equally dividing the room α in vertical and horizontal directions, the coordinates of the areas 9 may be easily obtained based on the size of the room α which may be acquired through actual measurement or from a layout drawing of the room α, for example. Thus, the corresponding area 9 that includes the center coordinates O of the detection cell 502 of each thermopile may be determined based on the coordinates of the areas 9.

Note that the correlation of the detection cell 502 of each thermopile with a corresponding area 9 does not necessarily have to be performed by comparing the center coordinates O of the detection cell 502 and the coordinates of a given area 9 and determining whether the center coordinates are included in the area 9. For example, in some embodiments, a determination may be made as to whether at least one corner of a detection cell 502 is included in a given area 9. Note that in a case where a determination is made as to whether all four corners of a detection cell 502 are included in a given area 9, the number of areas 9 that are determined to include a heat source tends to increase. Thus, implementation of such a determination may be suitable in a case where lighting and air conditioning are desirably controlled to overestimate rather than underestimate the presence of a person, for example.

Also, in some embodiments, when calculating the center coordinates O of a detection cell 502, the height Z may be set a height at which a person is likely to be located instead of the height of the ceiling β. For example, the height Z may be set to approximately 110 cm as the height at which a person is likely to be located. In this way, a detection cell 502 may be correlated with an area 9 where a person is actually located, for example.

As described above, although the heat source data obtained by the detection apparatus 3 is in a distorted shape, the heat source data can be converted into heat source data of each area 9 within the room α by implementing a correlation process as illustrated in FIG. 22, for example.

Note that in the above-described process of FIG. 22, logical sum processing is applied in which the presence of a heat source is determined when at least one set of center coordinates of a detection cell 502 with “1” set up as the heat source data is included in a certain area 9. On the other hand, even if the center coordinates of two or more detection cells 502 with “1” set up as the heat source data are included in a certain area 9, only one heat source is determined to be present in the area 9. In this way, an erroneous determination that a person is not present despite the presence of a person in the area 9 can be reduced. For example, the above process may be useful when the area 9 is relatively large.

Also, note that the center coordinates O of a detection cell 502 does not necessarily have to be the geometric center but may also be the center of gravity of the detection cell 502, for example. Further, the center coordinates O is not limited to the geometric center or the center of gravity but may be any point within the detection cell 502. This is because a heat source located at any point within the detection cell 502 may be detected by the corresponding thermopile sensor.

Also, note that in some embodiments, the process of FIG. 22 may be implemented by the detection apparatus 3, rather than the management system 8, for example. Alternatively, the process of FIG. 22 may be performed by the first control target apparatus 1, for example.

<Control Data Generation>

In the following, example processes for generating control data for the first control target apparatus 1 and the second control target apparatus 2 in step S28 of FIG. 10 are described.

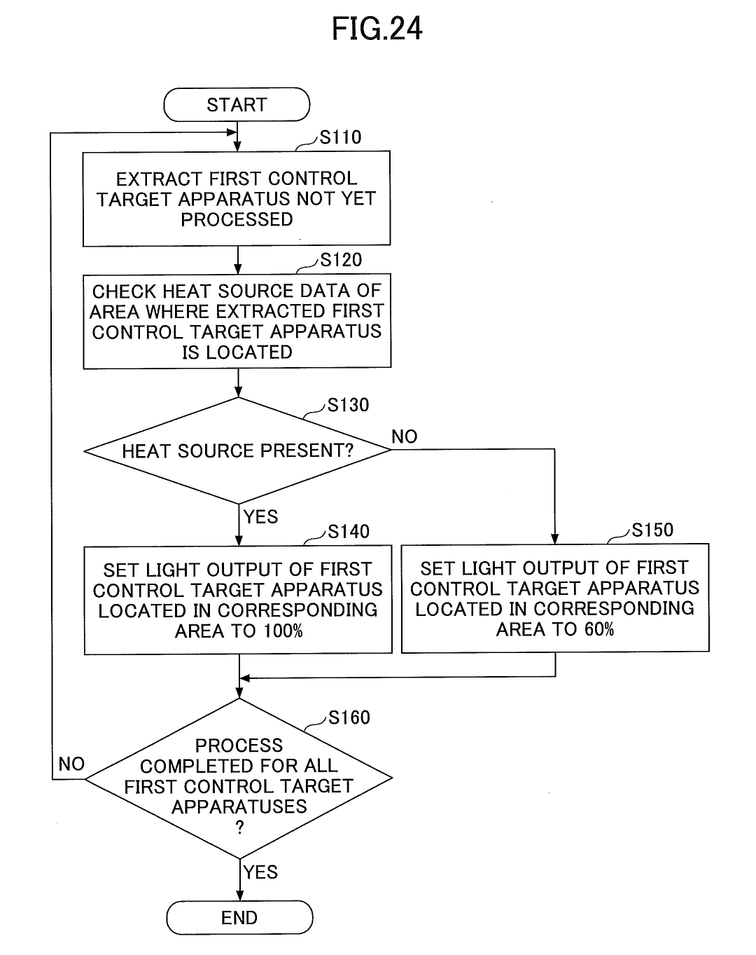

FIG. 24 is a flowchart illustrating an example process implemented by the generation unit 84 for generating control data for the first control target apparatus 1 relating to the amount of light to be output by an LED lighting apparatus that corresponds to the first control target apparatus 1.

In step S110, the generation unit 84 extracts one first control target apparatus 1 that has not yet been subjected to the present process. Note that a first control target apparatus 1 that has not yet been subjected to the present process refers to a first control target apparatus 1 for which control data has not yet been determined (generated).

Then, in step S120, the generation unit 84 refers to the heat source data of the area 9 where the extracted first control target apparatus 1 is located. Note that because the apparatus ID of the first control target apparatus 1 is the same as the area ID of the area 9 where the first control target apparatus 1 is located, the presence/absence of a heat source can be read from the heat source data of the corresponding area 9.

Then, in step S130, the generation unit 84 determines whether a heat source is present in the area 9 where the first control target apparatus 1 is located. That is, the generation unit 84 determines whether “1” is set up as the heat source data of the corresponding area 9.

If the heat source data of the area 9 where the first control target apparatus 1 is located is set to “1” (YES in S130), the generation unit 84 determines the amount of light to be output by the first control target apparatus 1 extracted in step S110 as 100% and generates control data based thereon (step S140). Note that the light output “100%” is set up in association with the heat source data “1” in the control guide management table of FIG. 7A.

If the heat source data of the area 9 where the first control target apparatus 1 is located is not set to “1” (NO in S130), i.e., if the heat source data of the area 9 is set to “0”, the generation unit 84 determines the amount of light to be output by the first control target apparatus 1 extracted in step S110 as 60% and generates control data based thereon (step S150). Note that the light output “60%” is set up in association with the heat source data “0” in the control guideline management table of FIG. 7A.

Then, in step S160, the generation unit 84 determines whether control data has been generated for all the first control target apparatuses 1 to be controlled. If a negative determination (NO) is made in step S160, the process returns to step S110 and the generation unit 84 repeats the processes of steps S110 to S150. If a positive determination (YES) is made in step S160, the process of FIG. 24 is ended.

In this way, control data can be generated with respect to all of the first control target apparatuses 1 corresponding to LED lighting apparatuses subject to lighting control based on the presence/absence of a heat source (presence/absence of a person) in the areas 9 where the first control target apparatuses 1 are located.

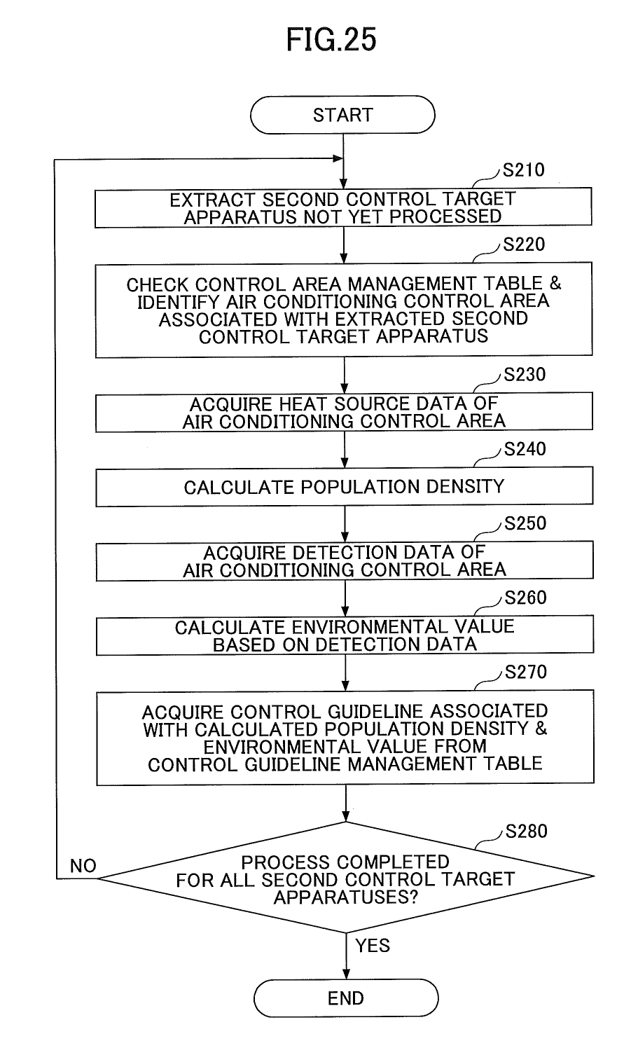

FIG. 25 is a flowchart illustrating an example process implemented by the generation unit 84 for generating control data for the second control target apparatus 1 for controlling an air conditioner that corresponds to the second control target apparatus 2.

In step S210, the generation unit 84 extracts one second control target apparatus 2 that has not yet been subjected to the present process. Note that a second control target apparatus 2 that has not yet been subjected to the present process refers to a second control target apparatus 2 for which control data has not yet been determined (generated).

Then, in step S220, the generation unit 84 refers to the control area management table as illustrated in FIG. 8 to determine the area IDs associated with the extracted second control target apparatus 2 and identify the corresponding areas 9 surrounding the extracted second control target apparatus 2.

Then, in step S230, the generation unit 84 acquires heat source data of the surrounding areas 9 identified in step S220. Note that the heat source data is transmitted from the detection apparatus 3 to the management system 8 in step S24 of FIG. 10. Then, in step S240, the generation unit 84 calculates the population density in the manner described above.

Then, in step S250, the generation unit 84 acquires the detection data of the surrounding areas 9 identified in step S220. Note that the detection data is transmitted from the detection apparatus 3 to the management system in step S24 of FIG. 10.

Then, in step S260, the generation unit 84 calculates environmental values based on the acquired detection data. Specifically, the generation unit 84 obtains the average of the temperature data of the surrounding areas 9 identified in step S220. As for the humidity, only one set of humidity data may be transmitted from one detection apparatus 3, and in this case, the generation unit 84 may use the humidity data included in the acquired detection data as is, for example. The average of the temperature data and the humidity data are examples of the environmental values calculated by the generation unit 84. Also, in some embodiments, the environmental values may also include illuminance data.

Then, in step S270, the generation unit 84 acquires a corresponding control guideline associated with the calculated population density and environmental values from the control guideline management table as illustrated in FIG. 7B. Specifically, the generation unit 84 first calculates the temperature gap between the current target temperature value and the environmental value (temperature). Note that the target temperature value is controlled by the generation unit 84 and is therefore a known value. Then, the generation unit 84 extracts (reads) the corresponding control guideline associated with the population density calculated in step S240 and the temperature gap and humidity and sets the extracted control guideline as the control data for the second control target apparatus 2.

Then, in step S280, the generation unit 84 determines whether control data has been generated for all the second control target apparatuses 2 to be controlled. If a negative determination (NO) is made in step S80, the process returns to step S210 and the generation unit 84 repeats the processes of steps S210 to S270. If a positive determination (YES) is made in step S280, the process of FIG. 25 is ended.

In this way, control data can be generated with respect to all the second control target apparatuses 2 corresponding to air conditioners that are subject to air conditioning control based on the population density and the environmental values of the control areas of the second control target apparatuses 2.

<Area Size>

The size of one area 9 is not fixed but may be appropriately adjusted according to the size of the room α, the number of people, the number of the first control target apparatuses 1, the number of the second control target apparatuses 2, and the like. For example, if the area 9 is too large, a plurality of persons may be present in one area 9 and the presence of a heat source may always be detected to thereby compromise energy conservation efforts. On the other hand, if the area 9 is too small, even if control is performed based on the presence/absence of a person in each area 9, comfort and energy conservation may not be improved as desired because the number of the first control target apparatuses 1 and the number of the second control target apparatuses 2 are fixed. Thus, in some embodiments, the management system 8 may be configured to automatically determine the size of one area 9 based on the ratio of the size of the room α to the number of people in the room α, for example. Note that the size of the room α and the number of people in the room α may be entered by an administrator, for example.

As can be appreciated from the above descriptions, the device control system 100 according to an embodiment of the present invention is capable of appropriately controlling both air conditioning and lighting by detecting the presence/absence of a person. In this way, the device control system 100 may be able to save energy and improve comfort. By detecting the presence/absence of a person with respect to each area 9 and individually controlling the lighting for each area 9, cases in which an entire room or a zone has to be illuminated due to the presence of even one person in the room or zone may be avoided to thereby facilitate energy conservation, for example. At the same time, at least the area 9 in which the presence of a person is detected may be appropriately illuminated such that comfort may not be compromised.

Also, according to an aspect of the present embodiment, the detection apparatus 3 may be able to detect temperatures at various positions from the temperature of the ceiling to the surface temperature of a desk, for example. Thus, the temperature of each area 9 may be obtained by detecting the temperature at a position in the room α where a person is located, for example. Note that typical control systems detect the temperature of air sucked into an air conditioning indoor unit to control air conditioning, and in such case, air conditioning is controlled based on the temperature close to the ceiling of a room. In this respect, the device control system 100 according to the present embodiment can control air conditioning based on the temperature of a position in the room α where a person is actually located to thereby provide a more comfortable environment for persons in the room, for example. Also, because the temperature can be controlled with respect to each control area controlled by the second control target apparatus 2, energy conservation performance can also be maintained. Also, note that measurement results have been obtained indicating that temperature fluctuations around a position where a person is located may be reduced by controlling air conditioning according to the present embodiment rather than controlling air conditioning based on the temperature at a position near the ceiling of a room.

Also, according to an aspect of the present embodiment, air conditioning may be controlled based on the population density, and in this way, heat generation that may be caused by the gathering of people may be predicted and the target temperature value may be changed accordingly before an actual temperature change occurs, for example. In this way, the device control system 100 according to the present embodiment may be able to provide a more comfortable temperature environment, for example.

### Other Application Examples

Although the present invention has been described above with respect to illustrative embodiments, the present invention is not limited to these embodiments, and numerous variations and modifications may be made without departing from the scope of the present invention.

For example, although the detection data used in the above-described embodiments include heat source data, temperature and humidity data, and illuminance data, other information, such as CO₂ concentration, odor, viruses, bacteria, or the like may be detected and included in the detection data.

Also, in the above-described embodiments, an LED lighting apparatus is illustrated as an example of the first control target apparatus 1. However, the first control target apparatus 1 is not limited to a lighting apparatus that uses an LED but may be any type of lighting apparatus. For example, an incandescent lamp, a fluorescent lamp, a halogen lamp, a high luminance discharge lamp, or the like may be used as the first control target apparatus 1.

Also, in the above-described embodiments, an air conditioner is illustrated as an example of the second control target apparatus 2. However, the second control target apparatus 2 is not limited to an air conditioner with a so-called heat pump but may be any apparatus that influences the sensory temperature and/or humidity. For example, the second control target apparatus 2 may be a simple fan, a dehumidifier, a humidifier, an air cleaner, or some type of heater, but is not limited thereto.

Also, in the above-described embodiments, a temperature distribution sensor is used to detect the presence/absence of a person. However, in other embodiments, the presence/absence of an animal other than a human being may be determined, for example. That is, any object that generates heat including animals, robots, and the like may be detected. Also, in some embodiments, a camera may be used as the temperature distribution sensor. In this case, a moving object may be detected by image processing, and people and/or animals may be detected using infrared rays, for example.

Also, the detection apparatus 3 is not limited to being installed in the first control target apparatus 1 corresponding to a lighting apparatus but may also be installed at other various locations, such as at a ventilation port of an air conditioner, or at a fire alarm device, for example.

Also, the functional configuration of the device control system 100 is not limited to the example configuration as illustrated in FIG. 5. That is, FIG. 5 merely illustrates one example distribution of functions of the device control system 100 to the management system 8, the first control target apparatus 1, and the second control target apparatus 2 to facilitate understanding of process operations implemented by the device control system 100. However, the present invention is by no way limited to the illustrated distribution of various process units and various names assigned thereto, for example. Also, processes of the device control system 100, the first control target apparatus 1, and the second control target apparatus 2 may be subdivided into further process units, for example. Also, a process implemented by a process unit may be divided into further process steps, for example.

Also, in some embodiments, the device control system 100 may include a plurality of management systems 8, and the functions of the management system 8 may be distributed to a plurality of servers, for example.

Also, in some embodiments, one or more of the databases included in the storage unit 8000 of the management system 8 may be provided on the communication network N, for example.

Note that the room α is an example of a predetermined space, the detection apparatus 3 is an example of an environmental information acquiring apparatus, the management system 8 is an example of a control apparatus, and the transceiver unit 81 is an example of an acquiring unit. Also, the information managed by the control guideline management DB 8002 is an example of control guideline information, the generation unit 84 is an example of a control data generation unit, and the cell conversion process unit 85 is an example of conversion unit.

What is claimed is:

1. A control apparatus configured to control a lighting apparatus and an air conditioning apparatus that are installed in a predetermined space by communicating with an environmental information acquiring apparatus configured to acquire environmental information relating to an environmental condition of the predetermined space, the control apparatus comprising:
a memory storing a program; and
a processor configured to execute the program to implement processes of
acquiring the environmental information from the environmental information acquiring apparatus; and
generating control data for the lighting apparatus and the air conditioning apparatus based on the acquired environmental information and control guideline information that is set up in advance in association with the acquired environmental information.

2. The control apparatus according to claim 1, wherein
the environmental information includes a surface temperature of an object or a person in the predetermined space; and
the processor generates the control data for the air conditioning apparatus based on the surface temperature and the control guideline information.

3. The control apparatus according to claim 1, wherein
the environmental information includes heat source information indicating the presence or absence of a heat source for each area of a plurality of areas of the predetermined space; and
the processor calculates a population density of the plurality of areas using the heat source information and generates the control data for the air conditioning apparatus based on the calculated population density and the control guideline information.

4. The control apparatus according to claim 3, wherein
the processor generates the control data for the air conditioning apparatus based on the calculated population density and the control guide information and transmits the generated control data to the air conditioning apparatus before a temperature change occurs in the predetermined space.

5. The control apparatus according to claim 1, wherein
the environmental information includes heat source information indicating the presence or absence of a heat source for each area of a plurality of areas of the predetermined space; and
the processor generates the control data that indicates an amount of light to be output by the lighting apparatus based on the heat source information and the control guideline information.

6. The control apparatus according to claim 1, wherein
the processor generates the control data for both the lighting apparatus and the air conditioning apparatus based on the same environmental information.

7. The control apparatus according to claim 1, wherein
the environmental information includes heat source information indicating the presence or absence of a heat source for each sensor detection range of a sensor installed in the environmental information acquiring apparatus; and
when the sensor is installed in the environmental information acquiring apparatus at an inclined angle with respect to a floor surface of the predetermined space, the processor further implements a process of correlating the heat source information for the each sensor detection range with an area of the predetermined space and converting the heat source information for the each sensor detection range into heat source information indicating the presence or absence of a heat source for each area of a plurality of areas of the predetermined space.

8. The control apparatus according to claim 7, wherein
the processor determines whether at least one set of coordinates of one sensor detection range overlaps with a corresponding area of the plurality of areas and sets up the heat source information for the one sensor detection range that includes at least one set of coordinates overlapping with the corresponding area as the heat source information for the corresponding area; and
when a plurality of sets of coordinates of a plurality of sensor detection ranges overlaps with the corresponding area of the plurality of areas, the processor sets up a logical sum of the heat source information for the plurality of sensor detection ranges as the heat source information for the corresponding area.

9. A device control system comprising:
an environmental information acquiring apparatus configured to acquire environmental information relating to an environmental condition of a predetermined space; and
a control apparatus configured to communicate with the environmental information acquiring apparatus to control a lighting apparatus and an air conditioning apparatus that are installed in the predetermined space, the control apparatus including a processor configured to execute a program stored in a memory to implement processes of
acquiring the environmental information from the environmental information acquiring apparatus; and
generating control data for the lighting apparatus and the air conditioning apparatus based on the acquired environmental information and control guideline information that is set up in advance in association with the acquired environmental information.

10. A non-transitory computer-readable medium storing a computer program to be executed by an information processing apparatus configured to control a lighting apparatus and an air conditioning apparatus that are installed in a predetermined space by communicating with an environmental information acquiring apparatus configured to acquire environmental information relating to an environmental condition of the predetermined space, the computer program, when executed, causing the information processing apparatus to implement processes of:
acquiring the environmental information from the environmental information acquiring apparatus; and
generating control data for the lighting apparatus and the air conditioning apparatus based on the acquired environmental information and control guideline information that is set up in advance in association with the acquired environmental information.
